(19) United States
(12) Patent Application Publication
(10) Pub. No.: US 2026/0361993 A1
(43) Pub. Date: Nov. 12, 2026

(54) SYSTEMS AND METHODS FOR CALIBRATED VISUAL TRACKING IN A SECURITY SYSTEM

(71) Applicant: Genetec Inc., Montréal (CA)

(72) Inventors: Philippe LORD, Laval (CA); Christian CHENARD-LEMIRE, Pointe-Claire (CA)

(21) Appl. No.: 19/203,770

(22) Filed: May 9, 2025

(51) Int. Cl. H04N 23/62; H04N 7/18; H04N 23/698

(52) U.S. Cl. CPC H04N 23/62; H04N 7/181; H04N 23/698

(57) ABSTRACT

A security system comprising a computing system adapted to cause display of video data generated by a first security camera within a graphical user interface; the computing system adapted to cause display of a visual representation of a second security camera at a first position within the graphical user interface, the first position indicative of a location of the second security camera relative to a viewpoint of the first security camera; the computing system adapted to detect an update associated with the viewpoint of the first security camera; and responsive to detecting the update, the computing system adapted to cause movement of the visual representation of the second security camera from the first position to a second position within the graphical user interface.

### FIELD

The present teachings relate generally to security systems and, more particularly, systems and methods for calibrated visual tracking in a security system.

### BACKGROUND

Security systems, which can include a variety of security devices such as surveillance cameras, access control devices, motion sensors, and/or alarms, are commonly used to monitor and/or restrict access to areas. For security systems that include a plurality of surveillance cameras, each surveillance camera in the security system is adapted to generate a feed of video data (e.g., video feed) associated with a respective area being monitored by the security system. As an example, a first surveillance camera may generate a video feed of a first area being monitored by the security system, a second surveillance camera may generate a video feed of a second area being monitored by the security system, and so on.

During operation of the security system, the various video feeds being generated by the surveillance cameras can be presented to an operator (e.g., a security personnel, a technician, etc.) via a display device. For example, a video feed generated by a surveillance camera can be displayed to a user within a video tile of a graphical user interface (GUI) presented on a display device. Using a software application associated with the security system, the operator can navigate through the one or more video feeds which are presented via the display device at a given time. For example, the operator can choose to view only a single video feed at a given time, view multiple video feeds at a given time, transition display of a video feed generated by a first surveillance camera to display of a video feed generated by a second surveillance camera, and/or perform one or more other actions associated with navigating through video feeds generated by the various surveillance cameras.

While viewing a video feed generated by a particular surveillance camera, an operator may notice a subject (e.g., a person of interest, an object of interest, etc.) appearing within the video feed. However, oftentimes, the subject appearing in the video feed is moving and eventually exits the field of view (FOV) of the surveillance camera generating the video feed. Thus, to continue monitoring the subject via a video feed, the operator must transition the display of video feed(s) to a video feed of an area that the subject has moved into and/or is moving towards. For security systems that include many different surveillance cameras, it can be difficult for an operator to follow subjects moving through the many video feeds being generated by the surveillance cameras included in the security system. To address this issue, various approaches to assisting operators with navigating between cameras and their respective viewpoints, for instance to follow subjects, have been developed.

In one conventional approach, shapes and/or other icons can be overlaid on the video tile of the GUI in which a video feed is presented to an operator. Hereinafter, the video tile of the GUI can simply be referred to as the “video tile.” When a subject begins to exit the video feed (e.g., moves out of the FOV of the camera generating the video feed), the operator can click on one of these shapes and/or icons to navigate to another video feed. For example, the operator can click on a shape or icon that is linked to a surveillance camera monitoring the area and/or direction to which the subject is moving.

However, at least one drawback to the above-described conventional approach is that each shape and/or icon inserted within a video feed must be manually configured. For example, whenever a new surveillance camera is added to the security system, respective shapes and/or icons linked to the video feed generated by the new surveillance camera must be manually configured for each nearby surveillance camera. Moreover, any time an existing surveillance camera is moved to a new location and/or is removed from the security system, any existing shapes and/or icons linked to the video feed generated by that existing surveillance camera must be manually updated and/or deleted. In that regard, for security systems in which there are many surveillance cameras (e.g., 100, 200, etc.), manually configuring links to nearby surveillance cameras can be very time consuming and cumbersome.

At least another drawback to the above-described conventional approach is that shapes and/or icons are fixed in place once overlaid on the video tile. For example, if a shape linked to a video feed generated by a first surveillance camera is overlaid on the right side of the video tile when a video feed generated by a second surveillance camera is displayed within the video tile, that shape is fixed on the right side of the video tile while the video feed generated by the second surveillance camera is displayed, unless manually adjusted. In that regard, if the shape was on the right side of the video tile to indicate a relationship between the respective viewpoints (e.g., angle and/or position from which a camera generates a video feed) of the first and second surveillance cameras, that indication of the spatial relationship is not preserved if the viewpoints of the first and/or second surveillance cameras are changed (e.g., either manually by a technician and/or using pan-tilt-zoom controls) and the shape remains overlaid on the right side of the video tile while the video feed generated by the second surveillance camera is displayed. For example, if the viewpoint of the second surveillance camera is rotated by 90 degrees, the shape linked to the video feed generated by the first surveillance camera will remain on the right side of the video tile while the video feed generated by the second surveillance camera is displayed within the video tile, and thus, will no longer accurately reflect the previously established relationship between the viewpoints of the first and second surveillance cameras.

Accordingly, it would be beneficial to have an alternative system and method for following subjects of interest through video feeds generated by surveillance cameras in a security system.

### SUMMARY

The needs set forth herein as well as further and other needs and advantages are addressed by the present embodiments, which illustrate solutions and advantages described below.

As used herein, the phrase “visual tracking” refers to the process of navigating between video feeds to continue monitoring a subject. The present teachings relate to automated calibration for visual tracking in a security system. In particular, the present teachings relate to automatically configuring security cameras with visual tracking functionality. Moreover, the present teachings relate to automatically calibrating the viewpoints of security cameras within a security system relative to the viewpoints of other security cameras included in the security system.

At least one technical advantage of the present teachings relative to existing solutions is that, with the present teachings, configuring security cameras with visual tracking functionality can be performed automatically. In that regard, for security systems that include many (e.g., 20, 50, 100, etc.) security cameras, the amount of time and effort required to configure security cameras with visual tracking functionality is greatly reduced when compared conventional approaches that require manually configuring visual tracking functionality for each security camera included in a security system.

At least another technical advantage of the present teachings relative to existing solutions is that, with the present teachings, visual tracking features implemented in conjunction with a security camera can be automatically updated when calibrating the viewpoint of a given security camera with respect to the viewpoints of other security cameras. In that regard, unlike conventional approaches that rely on time consuming manual updates, the integrity of the spatial and/or directional relationships between security cameras that implement visual tracking can be preserved with quick and efficient updates.

One embodiment according to the present teachings includes, but is not limited to, a security system comprising a computing system adapted to cause display of video data generated by a first security camera within a graphical user interface; the computing system adapted to cause display of a visual representation of a second security camera at a first position within the graphical user interface, the first position indicative of a location of the second security camera relative to a viewpoint of the first security camera, the computing system adapted to detect an update associated with the viewpoint of the first security camera, and responsive to detecting the update, the computing system adapted to cause movement of the visual representation of the second security camera from the first position to a second position within the graphical user interface.

Another embodiment according to the present teachings includes, but is not limited to, a security system comprising a computing system adapted to cause display of video data generated by a first security camera within a first portion of a graphical user interface, the computing system adapted to cause display of a visual representation of a second security camera within a second portion of the graphical user interface, the computing system adapted to cause display of a visual representation of a third security camera within the second portion, the computing system adapted to detect a user input associated with the visual representation of the second security camera and a first space within the first portion, the first space indicative of a location of the second security camera relative to a viewpoint of the first security camera, the computing system adapted to determine an orientation value associated with the viewpoint of the first security camera based in part on the user input, and the computing system adapted to cause, based at least in part on the orientation value and a location of the third security camera, display of another visual representation of the third security camera at a second space within the first portion, the second space is indicative of the location of the third security camera relative to the viewpoint of the first security camera.

Another embodiment according to the present teachings includes, but is not limited to, a security system managing at least one security camera adapted to receive video data associated with a first security camera at a first location, the computing system adapted to cause display of the video data within a first portion of a graphical user interface, the computing system adapted to cause display of a visual representation of a second security camera within a second portion of the graphical user interface, the second security camera at a second location, the computing system adapted to detect a user interaction associated with the visual representation of the second security camera and a first space within the first portion of the graphical user interface, the first space indicative of a relationship between the second security camera and a viewpoint of the first security camera, the computing system adapted to cause display of another visual representation of the second security camera at the first space, the computing system adapted to determine an orientation value associated with the viewpoint of the first security camera based in part on the relationship, and the computing system adapted to cause, based at least in part on the orientation value, display of a visual representation of the third security camera at a second space within the first portion of the graphical user interface.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an illustration of an example security system, according to the present teachings.

FIG. 2 is a block diagram of a security camera that may be implemented in conjunction with a security system, according to the present teachings.

FIG. 3 is a block diagram of a security system server that may be implemented in conjunction with a computing system, according to the present teachings.

FIG. 4 is a block diagram of a security system computing device that may be implemented in conjunction with a computing system, according to the present teachings.

FIGS. 5A and 5B illustrate an example graphical user interface that is presented to a user for adding a new security camera to a security system, according to the present teachings.

FIGS. 6A-6U illustrate an example graphical user interface that is presented to a user for configuring security cameras with visual tracking functionality, according to the present teachings.

FIGS. 7A-7H illustrate an example graphical user interface that is presented to a user for configuring security cameras with visual tracking functionality, according to the present teachings.

FIG. 8 is a flow diagram of method steps for configuring security cameras with visual tracking functionality, according to the present teachings.

FIGS. 9A-9E illustrate an example graphical user interface that is presented to a user for calibrating viewpoints of security cameras, according to the present teachings.

FIGS. 10A-10C illustrate an example graphical user interface that is presented to a user for calibrating viewpoints of security cameras, according to the present teachings.

FIG. 11 is a flow diagram of method steps for calibrating a viewpoint of a security camera, according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of a patent issued on this application in interpreting the claims appended hereto, it is noted that none of the appended claims or claim elements are intended to invoke 35 U.S.C. 112(f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Any direction referred to herein, such as “top,” “bottom,” “ ”left,“ ” “right,” “upper,” “lower,” “above,” below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

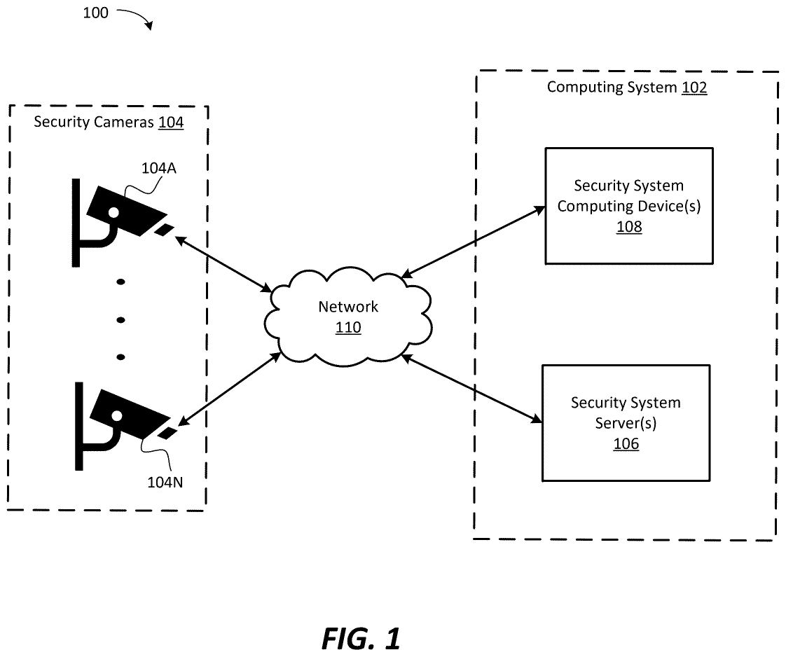

Referring now to FIG. 1, shown is an example security system 100, according to the present teachings. As shown, the security system 100 includes a computing system 102 that is in electronic communication with a plurality of security cameras 104 that generate video data. The computing system 102 may include any number of computers/processors, which may communicate with each other over a network and rely on distributed computing resources. In some examples, the computing system 102 may be in the form of one or more servers.

In the illustrated example of FIG. 1, the computing system 102 includes one or more security system servers 106 and one or more security system computing devices 108, each of which are connected via a communications network 110. In the following description, the one or more security system servers 106 may be collectively referred to as a security system server 106 and the one or more security system computing devices 108 may be collectively referred to as a security system computing device 108. In some examples, the security system server 106 and the security system computing device 108 can be implemented as a single computing device. In such examples, the functionality described herein as being performed by the security system server 106 and the security system computing device 108 can be performed by a single computing device.

The plurality of security cameras 104 can be implemented using, for example, surveillance cameras (including license plate recognition cameras) that generate feeds of video data. In some examples, the security cameras 104 are fixed cameras that have stationary fields of view. In some examples, the security cameras 104 include pan-tilt-zoom (PTZ) cameras, domed cameras, 360° cameras, and the like (some of which may be treated as virtual PTZ cameras in by the security system 100). In some examples, the security cameras 104 include a combination of both fixed and PTZ cameras. In some examples, mobile computing devices such as smartphones, tablets, or wearable devices can be implemented as security cameras 104, as these mobile computing devices may contain cameras, microphones, and/or other sensors that can be used to generate video data. In the following description, the plurality of security cameras 104 be collectively referred to as a security camera 104.

Although not shown, in some examples, the security system 100 can further include one or more other types of security devices. For example, the security system 100 can include one or more of motion sensors, alarms, access controls (e.g., door locks), and/or any other suitable type of security device.

One or more of the security cameras 104 may be connected to the computing system 102 via the communications network 110. For example, a security camera 104 can be connected the security system server 106 and/or the security system computing device 108 via the communications network 110. In some examples, the security system computing device 108 can be connected directly to one or more security cameras 104, for example via a wired connection, without using the communications network 110.

The communications network 110 can be, for example, a combination of one or more of a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.), a local area network (LAN), a neighborhood area network (NAN), a home area network (HAN), and/or a personal area network (PAN) employing any of a variety of communications protocols, such as Wi-Fi, Bluetooth, ZigBee, etc. In some examples, one or more other types of networks can be used to implement the communications network 110.

During operation of the security system 100, the security cameras 104 generate feeds of video data and transmit the feeds of video data to the security system server 106 and/or the security system computing device 108. Hereinafter, a feed of video data can simply be referred to as “video data” and/or “video feed.” In some examples, a security camera 104 can transmit video data directly to the security system server 106 via the communications network 110. In other examples, a security camera 104 can transmit video data to the security system server 106 indirectly through one or more intermediary devices, such as a security system computing device 108 and/or one or more other network access points and/or nodes.

The security system server 106 can be implemented as one or more frontend servers, backend servers, and/or other remote servers adapted to provide cloud-based services (e.g., software as a service (Saas)), or portals, to the computing system 102. As will be described in more detail herein, with the cloud-based services hosted on the security system server 106, client computing devices included in the computing system 102 (e.g., the security system computing device 108) can access video data stored in and/or streamed by the security system 100, add new security cameras 104 to the security system 100, configure security cameras 104 with visual tracking functionality, and/or calibrate viewpoints of the security cameras 104 included in the security system 100.

In some examples, the security system server 106 can implement a security system portal through which third-party entities (e.g., first responders, dispatchers, integrators, etc.) and/or end users of the security system 100 (e.g., owners, employees, property managers, security personnel, etc.) can access and/or manage operation of the security system 100. For example, third-party entities and/or end users of the security system 100 can use a security system computing device 108 to access and/or manage operation of the security system 100. As will be described in more detail herein, accessing and/or managing operation of the security system 100 through the security system portal can include, without limitation, adding new security cameras 104 to the security system 100, viewing video data that was generated by the security cameras 104 and stored in the security system server 106, uploading video data that was generated by a security camera 104 from a computing device (e.g., security system computing device 108) to the security system server 106, configuring security cameras 104 with visual tracking functionality, calibrating viewpoints of security cameras 104, and/or various other management and control features associated with the security system 100.

As used herein, the term “viewpoint” refers to the physical angle and location from which a security camera 104 captures, or generates, video data. In that regard, the viewpoint of a security camera 104 can be defined in part based on the physical location at which the security camera 104 is installed (e.g., GPS coordinates or the like), the azimuth of the security camera 104 (e.g., the direction in degrees, measured from true north, that the security camera 104 is facing), a bearing of the security camera 104 (e.g., the direction in degrees, measured from an established reference, that the security camera 104 is facing), a degree of rotation of the security camera 104 (e.g., a panning value for a PTZ camera), and/or one or more other parameters and/or values indicative of an orientation of the security camera 104. In some examples, the physical location of a security camera 104 need not necessarily refer to a georeferenced location of the security camera 104. Rather, in some examples, the physical location of a security camera 104 can refer to a position and/or location of a security camera 104 relative to one or more other security cameras 104 and/or one or more other landmarks. For example, the physical location of a security camera 104 can refer to the position of the security camera 104 on a floor plan relative to one or more other security cameras 104 and/or other objects positioned on the floor plan.

For examples in which the security camera 104 is a PTZ camera, the viewpoint of the security camera 104 is defined in part based on the pan, tilt, and/or zoom values of the security camera 104. Moreover, for examples in which the security camera 104 is a PTZ camera, the viewpoint of the security camera 104 can be changed (e.g., rotated) by adjusting one or more of the pan, tilt, or zoom values. For examples in which the security camera 104 is a fixed camera, the pan, tilt, and/or zoom values can be set to fixed values by default.

As described herein, “visual tracking” refers to the act of navigating between different video feeds generated by the security cameras 104 to monitor, or track, a subject. For example, while viewing a video feed (whether live or playback) generated by a first security camera 104A (e.g., via a display device on the security system computing device 108), an operator may notice a subject appearing within the video feed. However, oftentimes, the subject appearing in the video feed is moving and eventually exits the field of view (FOV) or coverage of the security camera 104 that generated the video feed. Thus, to continue monitoring the subject via a video feed, the operator navigates to a video feed generated by a different security camera 104 that is located near the area to which the subject is moving. In doing so, the operator can “visually track” the subject as the subject moves in and out of the fields of view of the security cameras 104. However, for security systems in which there are many security cameras 104 (e.g., 20, 50, 100, etc.), it can be quite difficult for operators to visually track persons or objects of interest using conventional approaches.

As will be described in more detail herein, operators can use the security system computing device 108 in conjunction with the security system server 106 to implement easy and efficient visual tracking. With the disclosed techniques, the security system computing device 108 can be used to automatically configure security cameras 104 with visual tracking functionality. Through this automatic configuration, visual representations (e.g., icons, text, etc.) of nearby security cameras 104 can be overlaid on the video tile in which the video feed generated by a first security camera 104 is displayed at respective positions that correspond to the relationships between the viewpoint of the first security camera 104 and the locations and/or viewpoints of the nearby security cameras 104. In that regard, while an operator is viewing the video feed generated by the first security camera 104 and a subject exits the video feed, to continue visually tracking the subject, the operator can quickly navigate (whether in a separate video tile or in the same video tile) to a video feed corresponding to the area in which the subject is moving by selecting a visual representation of the nearby security camera 104 that is overlaid on the video tile displaying the video feed at a position where the subject exits the video feed.

As an example, if a second security camera 104 captures video data of an area located to the right of the viewpoint of the first security camera 104 (e.g., to the right of the area of which the first security camera 104 captures video data), with the disclosed techniques, a visual representation of the second security camera 104 can be overlaid the right side of the video tile that displays the feed generated by the first security camera 104. In that regard, if while an operator is viewing the video feed generated by the first security camera 104 a subject exits the right side of the video feed, to continue visually tracking the subject, the operator can quickly navigate to the video feed generated by the second security camera 104 by selecting the visual representation of the nearby second security camera 104 that is overlaid the right side of the video tile.

Moreover, with the disclosed techniques, the security system computing device 108 can be used in conjunction with the security system server 106 to automatically generate virtual representations of nearby security cameras 104 based on a calibrated viewpoint of one or more security cameras 104 with respect to the positions of other security cameras 104 included in the security system 100. When calibrating the viewpoint of a first security camera 104, the position at which a visual representation of a second security camera 104 is overlaid on the video tile displaying a video feed generated by the first security camera 104 can be automatically updated (e.g., moved) based on one or more of (i) detected changes in the viewpoint of the first security camera 104 (e.g., detected changes in the position and/or angle of the first security camera 104) (ii) detected changes in the position of a second security camera 104, and/or (iii) detected changes in the position of a third security camera 104. As will be described in more detail herein, a change in the viewpoint of the first security camera 104 can be indicative of a change in a relationship (e.g., whether implicit or explicitly defined) between the viewpoints of the first security camera 104 and the respective viewpoints of nearby second and third security cameras 104. Moreover, a change in the position a second security camera 104 can be indicative of a change in a relationship (e.g., whether implicit or explicitly defined) between the viewpoint of a first security camera 104 and the viewpoint of a second security camera 104. In some examples, a change in the position a second security camera 104 can further be indicative of a change in a relationship (e.g., whether implicit or explicitly defined) between the viewpoint of a first security camera 104 and the viewpoint of a third security camera 104.

In some examples, when calibrating the viewpoint of a first security camera 104, the position at which a visual representation of a second security camera 104 is overlaid on the video tile displaying a video feed generated by the first security camera 104 can be automatically updated (e.g., moved) based on one or more of (i) detected changes in the viewpoint of the first security camera 104 (e.g., detected changes in the position and/or angle of the first security camera 104), (ii) detected changes in the viewpoint of a second security camera 104 (e.g., detected changes in the position and/or angle of the second security camera 104), and/or (iii) detected changes in the position of a third security camera 104 (e.g., detected changes in the position and/or angle of the third security camera 104). In such examples, a change in the position and/or angle of a second security camera 104 can also be indicative of a change in a relationship (e.g., whether implicit or explicitly defined) the viewpoint of a first security camera 104 and the viewpoint of a second security camera 104. Moreover, in such examples, a change in the position and/or angle of a second security camera 104 can further be indicative of a change in a relationship (e.g., whether implicit or explicitly defined) the viewpoint of a first security camera 104 and the viewpoint of a third security camera 104.

As a non-limiting example, the security system server 106 and/or the security system computing device 108 detects a change in the viewpoint of the first security camera 104 when the viewpoint of a first security camera 104 is rotated by 90 degrees (e.g., manually or using PTZ controls). In that regard, responsive to detecting the 90 degree rotation of the viewpoint of the first security camera 104, the security system server 106 and/or the security system computing device 108 can automatically move a visual representation of the second security camera 104 overlaid on the video tile displaying a video feed generated by the first security camera 104 from its initial position to a new position on the video tile that corresponds to the updated position and/or viewpoint of the second security camera 104 relative to the viewpoint of the first security camera 104. In that regard, while viewing the video feed generated by the first security camera 104, an operator can understand that the viewpoint of second security camera 104 corresponds to an area indicated by the updated position at which the visual representation of the second security camera 104 is overlaid on the video tile that displays the video feed generated by the first security camera 104.

As described herein, a change in the viewpoint of the first security camera 104 can indicate a change in the relationship (e.g., either implicit or explicit) between the viewpoint of the first security camera 104 and the viewpoint of the second security camera 104. In that regard, in some examples, the security system server 106 and/or the security system computing device 108 can determine a change in the relationship between the viewpoint of the first security camera 104 and the position and/or viewpoint of the second security camera 104 responsive to detecting the detecting the 90 degree rotation of the viewpoint of the first security camera 104. Then, in such examples, the security system server 106 and/or the security system computing device 108 can move the visual representation of the second security camera 104 overlaid on the video tile displaying a video feed generated by the first security camera 104 from its initial position to the new position on the video tile based on the determined change in the relationship between the viewpoint of the first security camera 104 and the position and/or viewpoint of the second security camera 104.

As another non-limiting example, if the security system server 106 and/or the security system computing device 108 detects a change in the relationship (e.g., implicit or explicit) between the viewpoint of the first security camera 104 and the viewpoint of the third security camera 104 (e.g., in response to user input, based on changes to the position and/or angle of the first security camera 104, and/or based on changes to the position and/or angle of the third security camera 104, etc.), with the disclosed techniques, an updated relationship between the viewpoint of the first security camera 104 and the viewpoint of the second security camera 104 can be automatically determined in response. For example, based in part on (i) a first relationship between the viewpoints of the second security camera 104 and the first security camera 104 and (ii) a second relationship between the viewpoints of the second security camera 104 and the third security camera 104, with the disclosed techniques, the security system server 106 and/or the security system computing device 108 can automatically determine an updated relationship between the viewpoints of the second security camera 104 and the first security camera 104 in response to determining there has been a change in the relationship between the viewpoint of the first security camera 104 and the viewpoint of the third security camera 104. Then, responsive to determining the updated relationship between the viewpoints of the second security camera 104 and the first security camera 104, the security system server 106 and/or the security system computing device 108 can update the position at which the visual representation of the second security camera 104B is overlaid on video tile that displays video feed generated by the first security camera 104 accordingly.

In a similar manner, if the security system server 106 and/or the security system computing device 108 detects a change in the relationship (e.g., implicit or explicit) between the viewpoint of the second security camera 104 and the viewpoint of the third security camera 104 (e.g., in response to user input, based on changes to the position and/or angle of the second security camera 104, and/or based on changes to the position and/or angle of the third security camera 104, etc.), with the disclosed techniques, an updated relationship between the viewpoints of the first security camera 104 and the second security camera 104 can be automatically determined in response. For example, based on (i) a first relationship between the viewpoints of the second security camera 104 and the first security camera 104 and (ii) a second relationship between the viewpoints of the first security camera 104 and the third security camera 104, with the disclosed techniques, the security system server 106 and/or the security system computing device 108 can automatically determine an updated relationship between the viewpoints of the first security camera 104 and the second security camera 104 in response to determining there has been a change in the relationship between the viewpoints of the second security camera 104 and the third security camera 104. Then, responsive to determining the updated relationship between the viewpoints of the second security camera 104 and the first security camera 104A, the security system server 106 and/or the security system computing device 108 can update the position at which the visual representation of the second security camera 104B is overlaid on video tile that displays video feed generated by the first security camera 104 accordingly.

Additional techniques for configuring security cameras 104 with visual tracking functionality and/or calibrating viewpoints of the security cameras 104 will be described in more detail below.

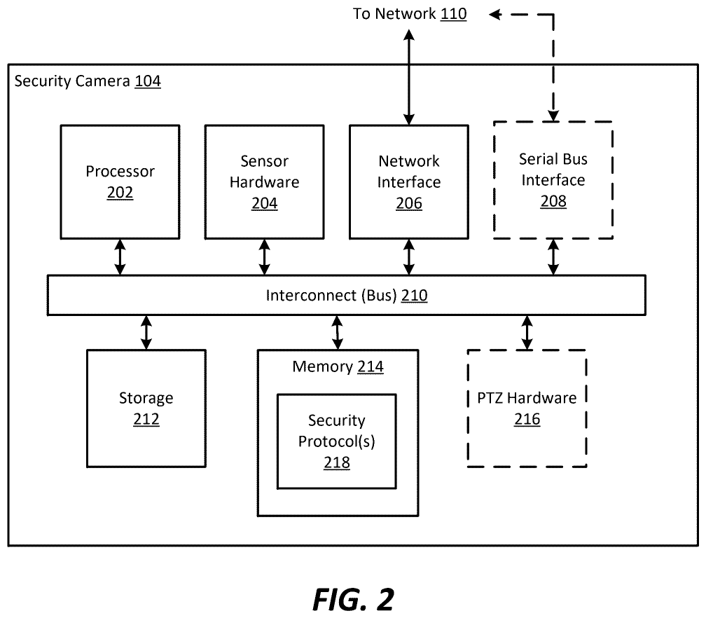

FIG. 2 is a block diagram of a security camera 104 that may be implemented in conjunction with the computing system 102, according to present teachings. As shown, the security camera 104 may include, without limitation, a processor 202, sensor hardware 204, a network interface 206, a serial bus interface 208, an interconnect 210, storage 212, and memory 214. The interconnect, or bus, 210 can include one or more wires, cables, traces, contacts, analog components, digital components, wireless connection components, or other suitable means for interconnecting hardware components of the security camera 104.

The sensor hardware 204 can include, without limitation, one or more of an image sensor, an audio sensor, a motion sensor, an RFID sensor, a barcode reader, and/or some other suitable sensing means. For examples in which the security camera 104 is a PTZ camera, the security camera 104 can further include PTZ hardware 216. The PTZ hardware 216 includes a combination of electrical and/or mechanical components (e.g., motors, actuators, linkages, etc.) that can be used to adjust the pan, tilt, and/or zoom of the security camera 104, which may be physically integrated with the security camera 104 or separate therefrom, in which case the PTZ hardware may comprise elements suitable for controlling the external hardware. For example, the PTZ hardware 206 can include one or more mechanisms for rotating the security camera 104 and/or otherwise adjusting the FOV of the security camera 104.

The processor 202 is adapted to control the security camera 104 (e.g., the sensor hardware 204 and/or the security hardware 206) to operate and generate video data in accordance with one or more security protocols 218 included in the memory 214. For an example in which the security camera 104 is a PTZ camera 104, the processor 202 also controls the pan, tilt, and/or zoom of the security camera 104 in accordance with the security protocols 218.

The processor 202 is further adapted to cause video data to be transmitted to the security system server 106 and/or the security system computing device 108, for instance via the network interface 206 and/or the serial bus interface 208. For example, the processor 202 uses the network interface 206 to transmit video data directly to the security system server 106 and/or the security system computing device 108 via the communications network 110. As another example, the processor 202 uses the network interface 206 to transmit video data to the security system server 106 indirectly via one or more intermediary devices, such as the security system computing device 108.

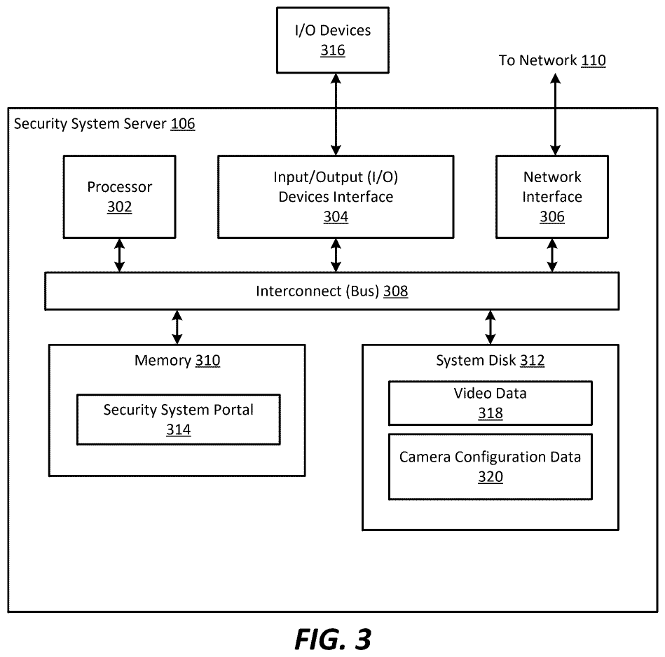

FIG. 3 is a block diagram of a security system server 106 that may be implemented in conjunction with the computing system 102, according to present teachings. As shown in FIG. 3, the security system server 106 includes, without limitation, a processor 302, an input/output (I/O) devices interface 304, a network interface 306, an interconnect 308, a system memory 310, and a system disk 312. The interconnect, or bus, 308 can include one or more wires, cables, traces, contacts, analog components, digital components, wireless connection components, and/or other suitable means for interconnecting hardware components of the security system server 106.

The processor 302 is adapted to retrieve and execute programming instructions, such as the security system portal 314. Similarly, the processor 302 is adapted to store application data in (e.g., software libraries) and retrieve application data from the system memory 310. The interconnect 308 is adapted to facilitate transmission of data, such as programming instructions and application data, between the processor 302, the I/O devices interface 304, the network interface 306, the system memory 310, and the system disk 312. The I/O devices interface 304 is adapted to receive input data from I/O devices 316 and transmit the input data to the processor 302 via the interconnect 308. For example, I/O devices 316 may include one or more buttons, a keyboard, a mouse, and/or other input devices. The I/O devices interface 304 is further adapted to receive output data from the processor 302 via the interconnect 308 and transmit the output data to the I/O devices 316. In some cases, the I/O devices 316 may provide input and receive output over one or more networked connections, for instance in cases in which access to the security system server 106 occurs over a remote connection (e.g., remote desktop, portal access, or the like).

The system disk 312 may include one or more hard disk drives, solid state storage devices, or similar storage devices. The system disk 312 is adapted to store, inter alia, non-volatile data such as files (e.g., audio files, video files, subtitles, application files, software libraries, etc.). For example, the system disk 312 is adapted to store video data 318 generated by security cameras 104 included in the security system 100. The system disk 312 is further adapted to store camera configuration data 320 associated with the security cameras 104. The camera configuration data 320 can include, without limitation, data such as names and/or other identifying information associated with the security cameras 104, information indicative of the types (e.g., fixed, PTZ, domed, etc.) of the security cameras 104 included in the security system 100, location information associated with the security cameras 104 (e.g., respective buildings, streets, landmarks, rooms, hallways, and/or other spaces at which each security camera 104 is installed), and/or other types of information associated with the security cameras 104.

In some examples, the camera configuration data 320 further includes orientation information associated with the security cameras 104 included in the security system 100. Orientation information associated with a security camera 104 can include, for example, geographic coordinates and/or other information that identifies the location at which the security camera 104 is located, data indicative of the azimuth (or other bearing) of the security camera 104 and/or a direction in which the security camera 104 is facing, a degree of rotation of the security camera 104, and/or other information that can be used to determine a viewpoint of the security camera 104. In some examples, orientation information can further include pan, tilt, and/or zoom values associated with the security cameras 104. As described herein, for security cameras 104 that are fixed and do not include PTZ functionality, the pan, tilt, and/or zoom values can be set to default values.

In some examples, the orientation information associated with a security camera 104 can include both an azimuth value and a map azimuth value. In such examples, the azimuth value refers to the physical direction the security camera 104 is viewing the world relative to “true North” and can be determined by combining multiple different values. Moreover, in such examples, the map azimuth value is a map-based “north” value. In some examples, the orientation information associated with a security camera 104 includes a panning value that is representative of the current value of the security camera 104 in its panning axis. In such examples, the panning value can be based on an internal reference (e.g., 0) of the security camera 104 and is typically expressed as a value between a minimum value and a maximum value. In some examples, the orientation information associated with a security camera 104 also includes a hardware offset value, which represents a difference between the internal reference of the security camera 104 and the azimuth of the security camera 104.

As described herein, the location and/or orientation information associated with security cameras 104 and stored as camera configuration data 320 can indicate one or more relationships between the respective locations and/or viewpoints of security cameras 104 included in the security system 100. In some examples, the camera configuration data 320 can further include information that explicitly defines these relationships. For example, the camera configuration data 320 can include information (e.g., angles, locations, etc.) that defines the positions of security camera viewpoints relative to each other. In other examples, the camera configuration data 320 does not include information that explicitly defines the relationships between the viewpoints of security cameras 104. Rather, in such examples, relationships between the viewpoints of security cameras 104 can simply be inferred and/or determined based on the location and/or orientation information associated with security cameras 104 included in the camera configuration data 320.

The system memory 310 includes software instructions for running the security system portal 314 described herein. The security system portal 314 can receive video data 318 generated by one or more security cameras 104 in the security system 100 and store the video data 318 in system disk 312. The security system portal 314 can also communicate with and remotely control the security cameras 104 included in the security system 100. Furthermore, the security system portal 314 can be used to implement any of the configuration and/or calibration functions described herein in conjunction with the security system computing device 108. For example, users of the security system computing device 108 can connect to the security system portal 314 to add new security cameras 104 to the security system 100, automatically configure security cameras 104 with visual tracking functionality, automatically calibrate the viewpoint of a security camera 104 with respect to other security cameras 104 included in the security system 100, and/or any of the other functions described herein.

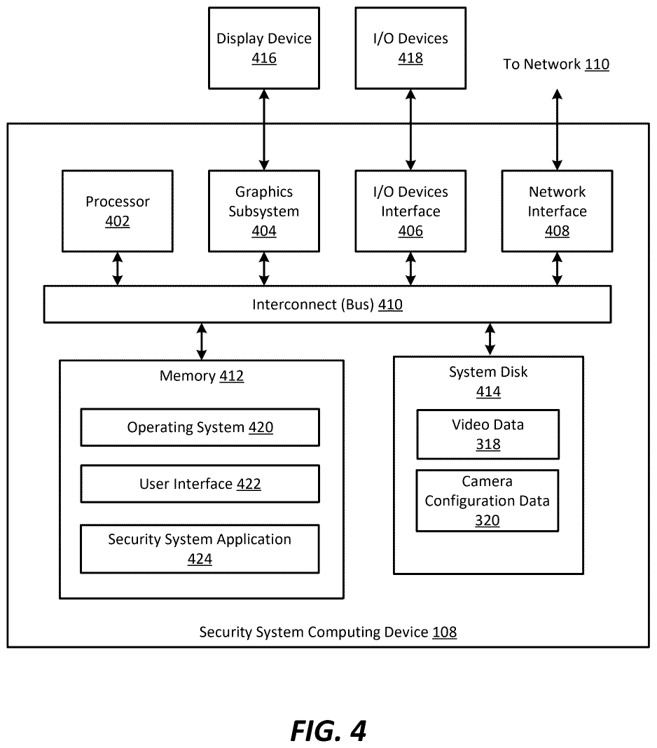

FIG. 4 is a block diagram of a security system computing device 108 that may be implemented in conjunction with the computing system 102, according to present teachings. The security system computing device 108 may be implemented as, for example, one or more of a desktop computer, a laptop, a tablet, a smart phone, a server, or some other similar computing device.

As shown, the security system computing device 108 may include, without limitation, a processor 402, a graphics subsystem 404, an I/O devices interface 406, a network interface 408, an interconnect 410, a memory subsystem 412, and a system disk 414. The interconnect 410 is adapted to facilitate transmission of data, such as programming instructions and application data, between the processor 402, the graphics subsystem 404, the I/O devices interface 406, the network interface 408, the memory subsystem 412, and the system disk 414.

In some embodiments, the processor 402 (e.g., a CPU or similar processor) is adapted to retrieve and execute programming instructions stored in the memory subsystem 412. Similarly, the processor 402 is adapted to store and retrieve application data (e.g., software libraries) residing in the memory subsystem 412 and/or the system disk 414. The interconnect 410 is adapted to facilitate transmission of data, such as programming instructions and application data, between the processor 402, the graphics subsystem 404, the I/O devices interface 406, the network interface 408, the memory subsystem 412, and the system disk 414.

In some embodiments, the graphics subsystem 404 is adapted to generate frames of image and/or video data and transmit the frames of image and/or video data to display device 416. In some embodiments, the graphics subsystem 404 may be integrated into an integrated circuit, along with the processor 402. The display device 416 may comprise any technically feasible means for generating an image for display. For example, the display device 416 may be fabricated using liquid crystal display (LCD) technology, cathode-ray technology, and light-emitting diode (LED) display technology. The display device 416 may include, for example, one or more monitors. In some examples, the display device 416 can be implemented in virtual and/or augmented reality. In such examples, the display device 416 can be integrated within augmented reality glasses and/or a virtual reality headset.

The input/output (I/O) device interface 406 is adapted to receive input data from user I/O devices 418 and transmit the input data to the processor 402 via the interconnect 410. For example, user I/O devices 418 may comprise one or more buttons, a keyboard, and a mouse or other pointing device. The I/O device interface 406 also includes an audio output unit adapted to generate an electrical audio output signal. User I/O devices 418 may comprise one or more speakers adapted to generate an acoustic output in response to the electrical audio output signal. In alternative embodiments, the display device 416 may include the speaker. In some examples, one or more security cameras 104 can be connected to the security system computing device 108 via the I/O devices interface 406.

The network interface 408 is adapted to transmit and receive packets of data via the network 110. For example, the network interface 408 is used to receive video data 318 from one or more security cameras 104, transmit video data 318 to the security system server 106, retrieve video data 318 from the security system server 106, access the security system portal 314 to configure security cameras 104 with visual tracking functionality, and/or calibrate viewpoints of security cameras 104. In some embodiments, the network interface 408 is adapted to communicate using the well-known Ethernet standard, one or more of the well-known WiFi standards, or any suitable combination of wired and wireless protocols, as appropriate. The network interface 408 is coupled to the processor 402 via the interconnect 410.

The system disk 414, such as a hard disk drive or flash memory storage drive, is adapted to store non-volatile data. For example, the system disk 414 can store video data 318 generated by the one or more security cameras 104. In some examples, the system disk 414 can store camera configuration data 320.

In some embodiments, the memory subsystem 412 includes programming instructions and application data that comprise an operating system 420, a user interface 422, and a security system application 424. The operating system 420 performs system management functions such as managing hardware devices including graphics subsystem 404, I/O device interface 406, the network interface 408, and system disk 414. The operating system 420 also provides process and memory management models for the user interface 422 and the security system application 424. The user interface 422, such as a GUI and object metaphor, provides a mechanism for user interaction with security system computing device 108. Persons skilled in the art will recognize the various operating systems and user interfaces that are well-known in the art and suitable for incorporation into the security system computing device 108.

In some examples, the security system application 424 is a web-based application that provides access to the security system portal 314 running on the security system server 106, and which, for instance, may run in or via a browser. In such examples, the security system application 424 can be used to perform one or more of the functions described herein with respect security system portal 314.

In some examples, the security system application 424 is a native software application that is stored locally in the memory 612 and/or the system disk 414. In such examples, the security system application 424 can perform one or more of the functions described herein with respect to the security system portal 314 locally on the security system computing device 108 without connecting to the security system portal 314.

In operation, the security system application 424 can be used to retrieve and view video data 318 generated by a security camera 104. For example, the security system application 424 can connect to the security system portal 314 and the security system portal 314 can cause the display of the video data 318 within a graphical user interface (GUI) of the security system application 424 presented on the display device 416. As another example, the security system application 424 can be used to view video data 318 stored locally in the system disk 414 and/or received directly from a security camera 104. Furthermore, the security system application 424 can be used to perform any of the configuration and/or calibration functions described herein. For example, the security system application 424 can be used to add new security cameras 104 to the security system 100, automatically configure security cameras 104 with visual tracking functionality, calibrate the viewpoint of a security camera 104 with respect to one or more other security cameras 104 included in the security system 100, and/or any of the other functions described herein. As described herein, in some examples, one or more steps for configuring a security camera 104 with visual tracking functionality and/or for calibrating the viewpoint of a security camera 104 with respect to one or more other security cameras 104 can be performed automatically by the security system application 424 without user intervention. In other examples, one or more steps for configuring a security camera 104 with visual tracking functionality and/or for calibrating the viewpoint of a security camera 104 with respect to one or more other security cameras 104 can be performed by the security system application 424 in response to user input.

In some examples, actions that can be performed with the security system application 424 depend on the credentials and/or permissions associated with the user of the security system computing device 108. For example, a user with administrative permissions may be permitted to perform more actions using security system application 424 than a user with standard and/or restricted permissions.

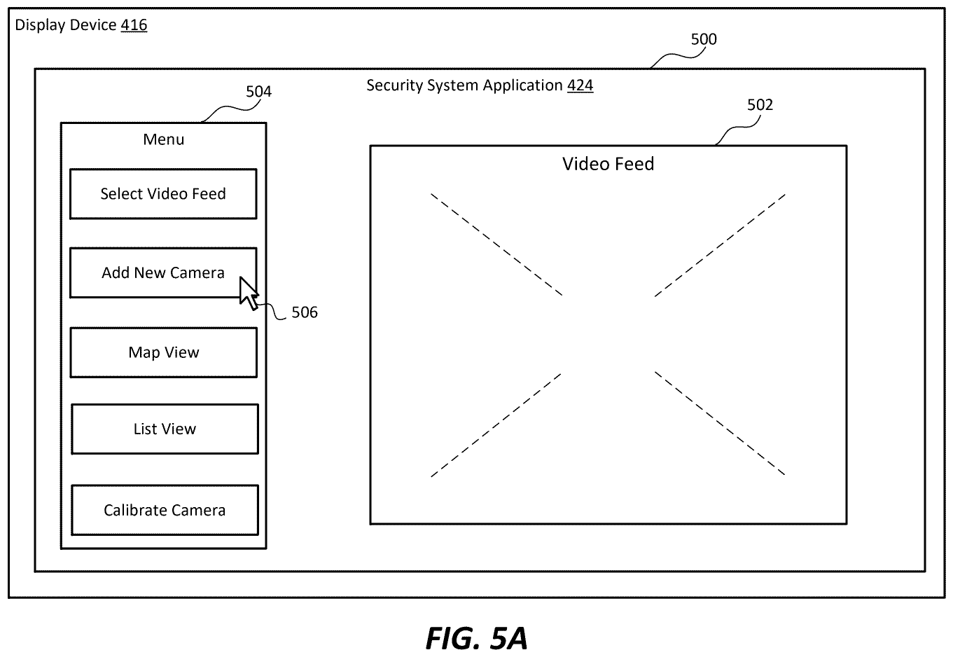

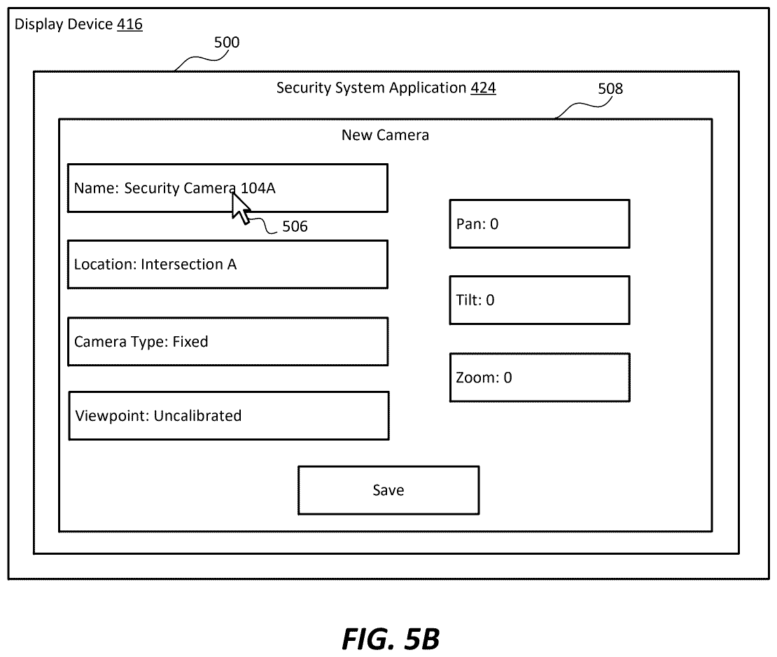

FIGS. 5A and 5B illustrate an example graphical user interface (GUI) 500 that is presented to a user for adding a new security camera 104 to a security system 100, according to the present teachings. For example, FIGS. 5A and 5B illustrate an example GUI 500 that is presented by the security system application 424 on the display device 416. As shown in FIG. 5A, the GUI 500 includes a video tile 502 and a menu 504. The video tile 502 can be used to display video data 318 generated by one or more of the security cameras 104.

In the illustrated example of FIG. 5A, the menu 504 comprises a plurality of selectable options that can be selected by a user of the security system computing device 108. For example, the menu 504 includes a “Select Video Feed” option for adjusting and/or changing the video data that is displayed within the video tile 502. As another example, the menu includes an “Add New Camera” option for adding a new security camera 104 to the security system 100. As will be described in more detail herein, the menu 504 can also include a “map view” option, a “list view” option, and a “Calibrate Camera” option. Persons skilled in the art should understand that the selectable options included in the menu 504 are provided as non-limiting examples, and that in other examples, the menu 504 can include more or fewer selectable options that the ones shown in FIG. 5A and subsequent figures described herein.

Also shown in FIG. 5A is a cursor 506. The cursor 506 can be, for example, used by a user of the security system computing device 108 to select and/or otherwise interact with the GUIs of the security system application 424 described herein. However, persons skilled in the art should understand that a cursor 506 is just one example means for interacting with a GUI of the security system application 424, and that in other examples, different means can be used to interact with a GUI of the security system application 424. For example, if the display device 416 is implemented as a touch screen display, a user can interact with a GUI of the security system application 424 using their finger, a stylus, and/or some other mechanism for interacting with a touch screen display. Moreover, for instances in which the display device 416 can implemented using augmented and/or virtual reality devices, gestures and/or movements by a user can be used to interact with the GUIs of the security system application 424. For simplicity of explanation, user interactions with GUIs of the security system application 424 will hereinafter be illustrated and described as being performed with a cursor 506. However, persons skilled in the art should understand that any functions illustrated and described herein as being performed with a cursor 506 could instead be performed using one or more other tools, mechanisms, and/or user gestures.

Referring back to FIG. 5A, a user can add a new security camera 104 to the security system 100 by selecting the “Add New Camera” option. Responsive to detecting a selection of the “Add New Camera” option, as shown in FIG. 5B, the security system application 424 presents a plurality of fields 508 associated with a new camera being added to the security system 100. In some examples, one or more of the plurality of fields 508 can be populated manually by a user, can be populated automatically by the security system portal 314, and/or can be populated automatically by the security system application 424.

In the illustrated example of FIG. 5B, the plurality of fields 508 includes a field for naming the new security camera 104, a field for inputting location information associated with the new security camera 104 (e.g., geographic coordinates of the location at which the new security camera 104 is installed, a qualitative description of the building, room, street, and/or other type of location at which the new security camera 104 is installed, and/or other location information not explicitly described herein), a field for indicating the type of the new security camera 104 (e.g., fixed, PTZ, domed, etc.), a field for indicating whether a viewpoint of the new security camera 104 has been calibrated, fields for the pan, tilt, and zoom values associate with the new security camera 104, and a save option for saving and/or submitting entry of the new camera 104 into the security system 100. In the illustrated example of FIG. 5B, the new security camera 104 being added to the security system 100 is named “security camera 104A,” is located at intersection A, is a fixed camera, and has an uncalibrated viewpoint. As also described herein, because security camera 104A is a fixed camera, the pant, tilt, and zoom values associated with security camera 104A are set to zero by default. In some examples, the pan, tilt, and/or zoom values can be set to some other non-zero value by default.

Persons skilled in the art should understand that the field options included in the plurality of fields 508 are provided as non-limiting examples, and that in other examples, the plurality of fields 508 can include more or fewer field options than the ones shown in FIG. 5B.

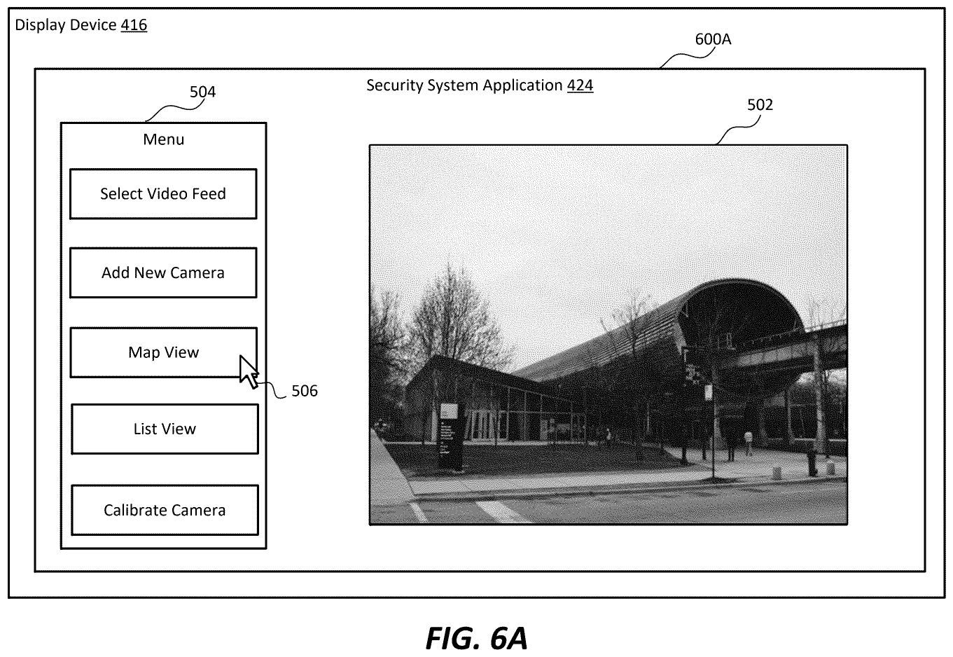

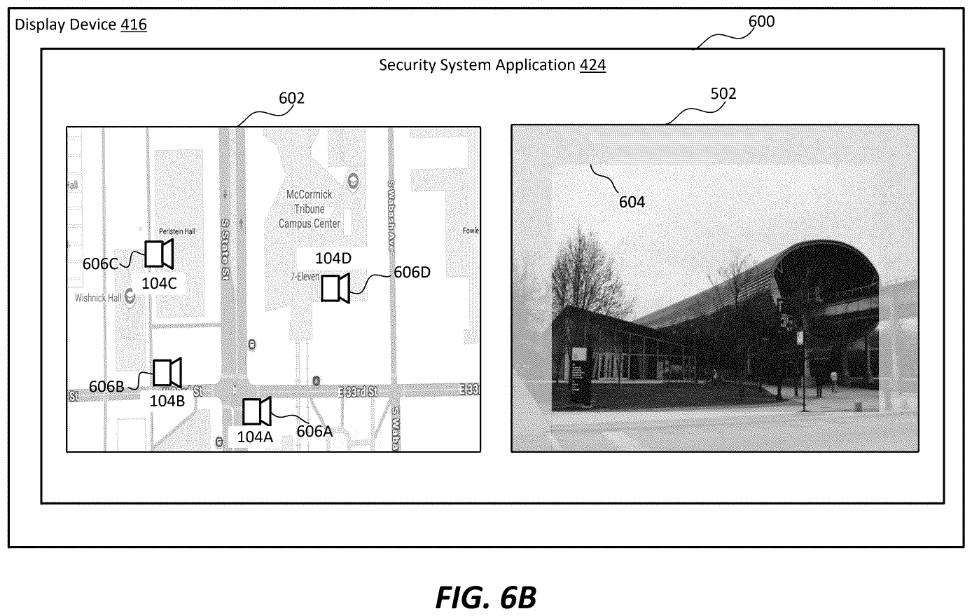

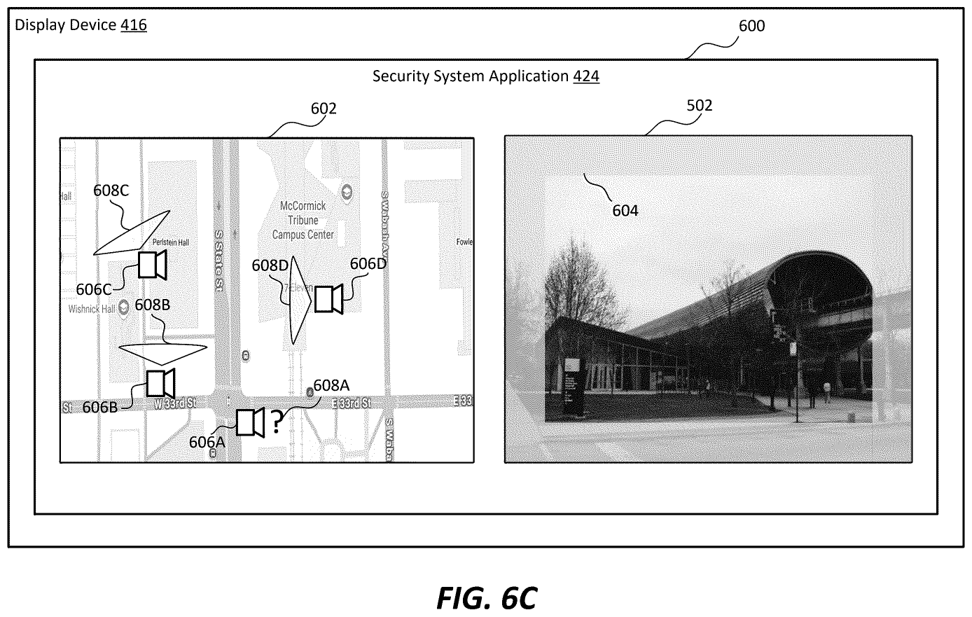

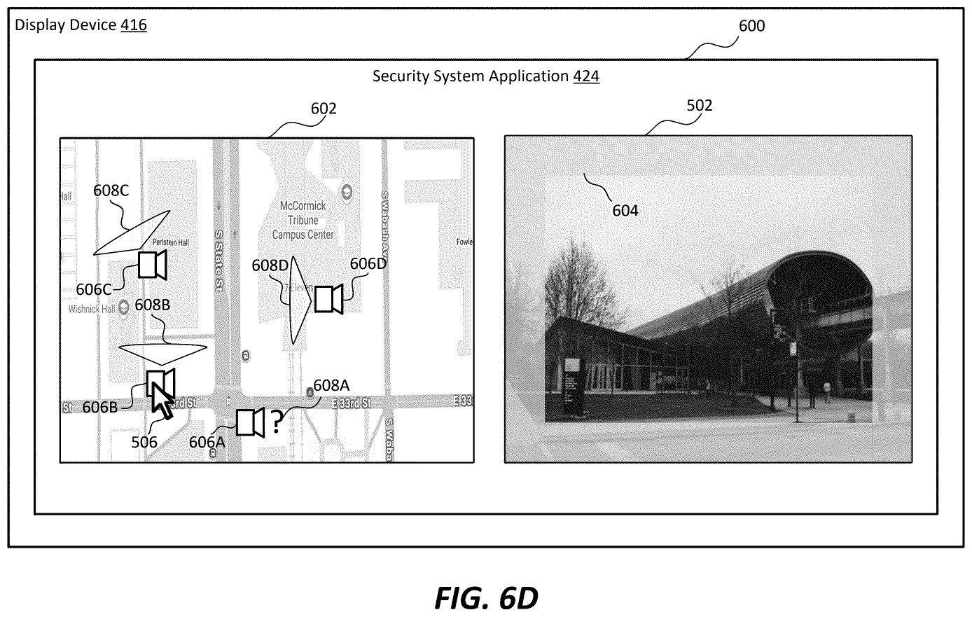

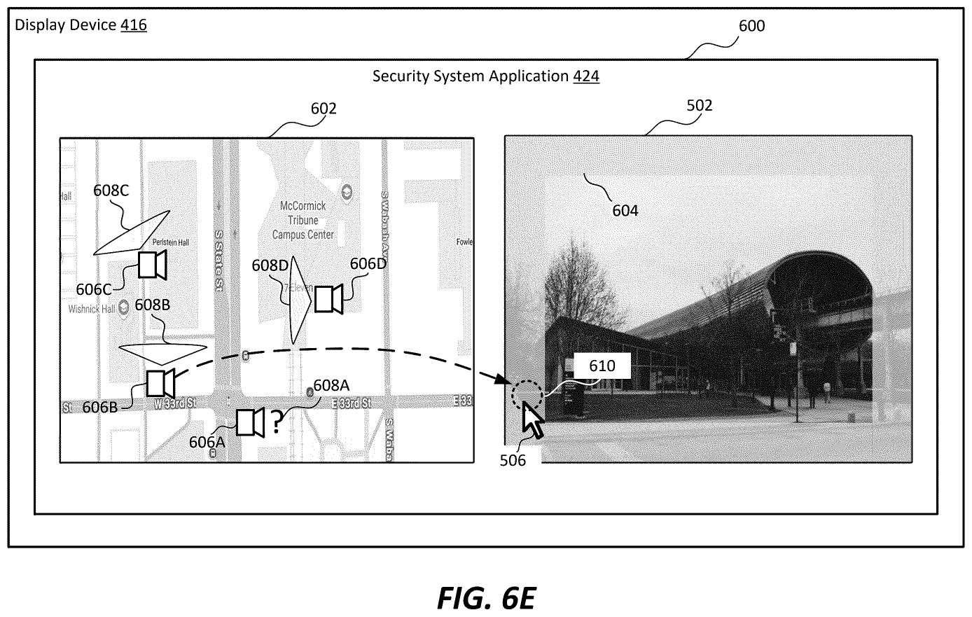

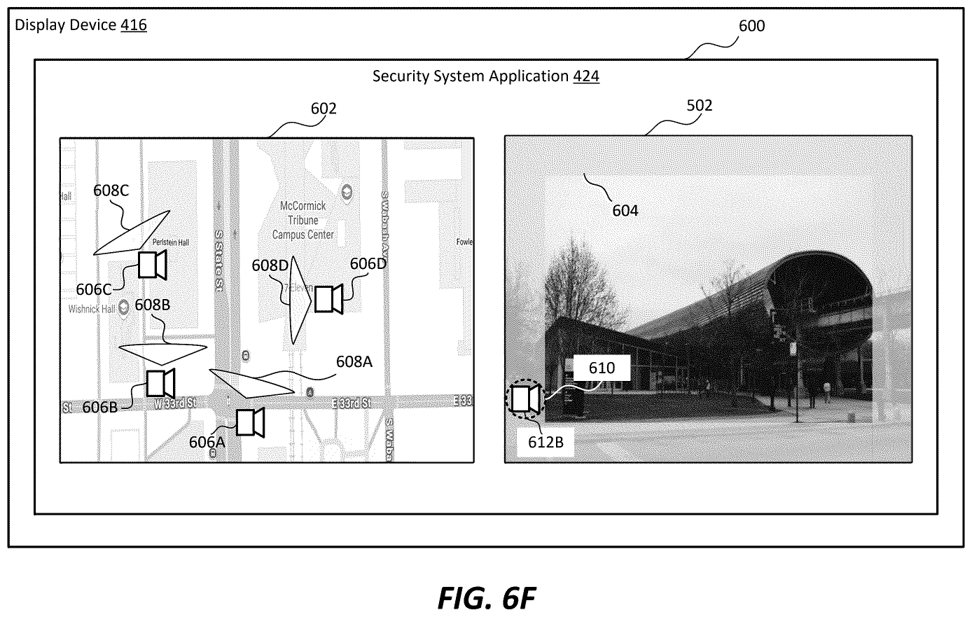

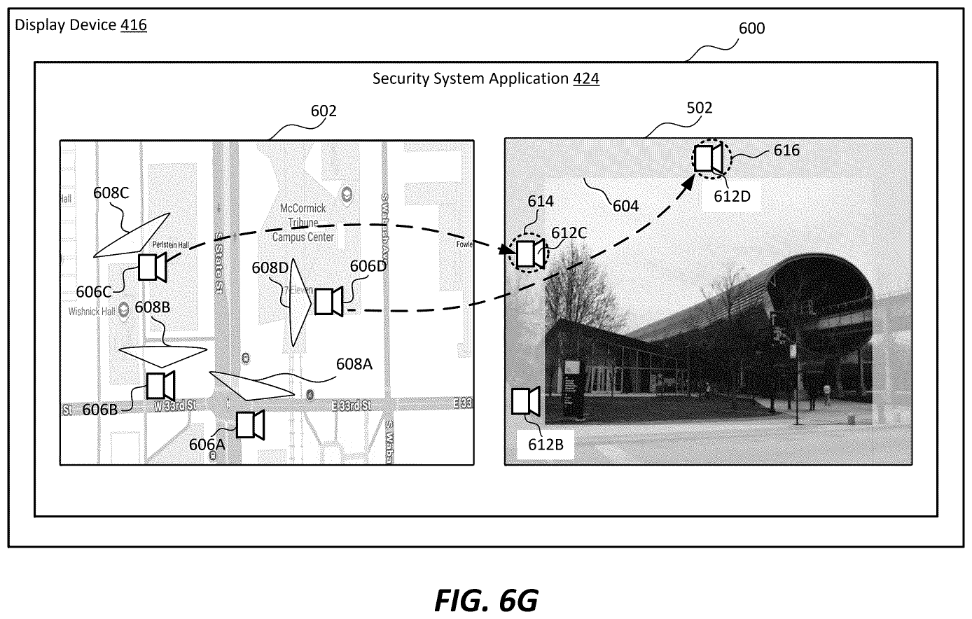

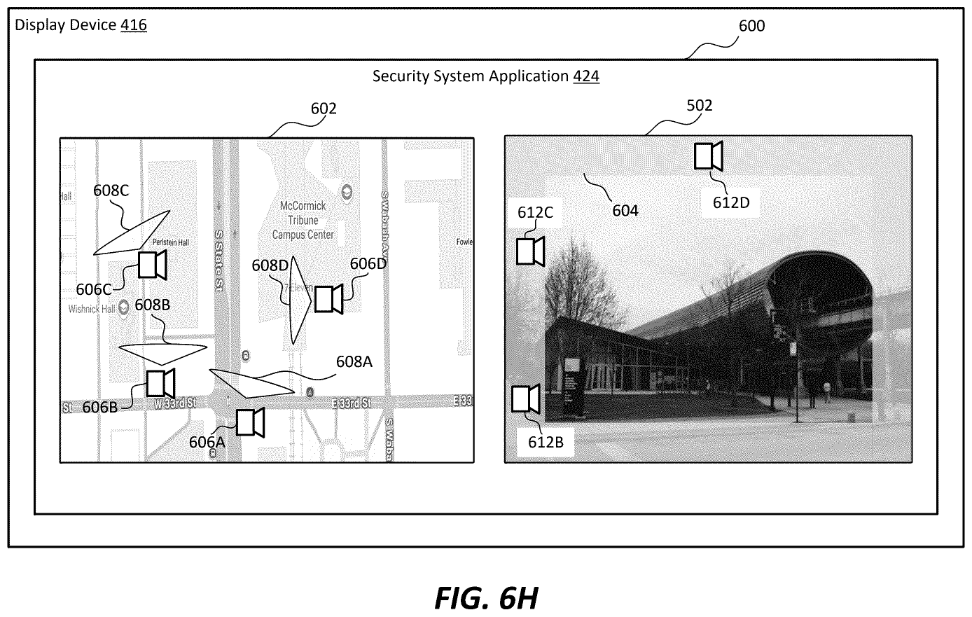

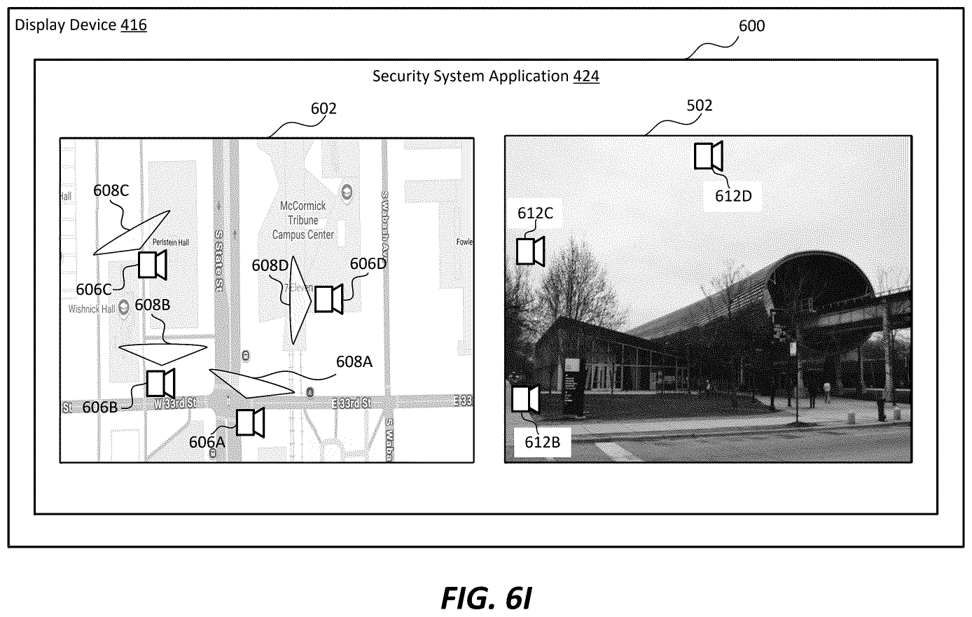

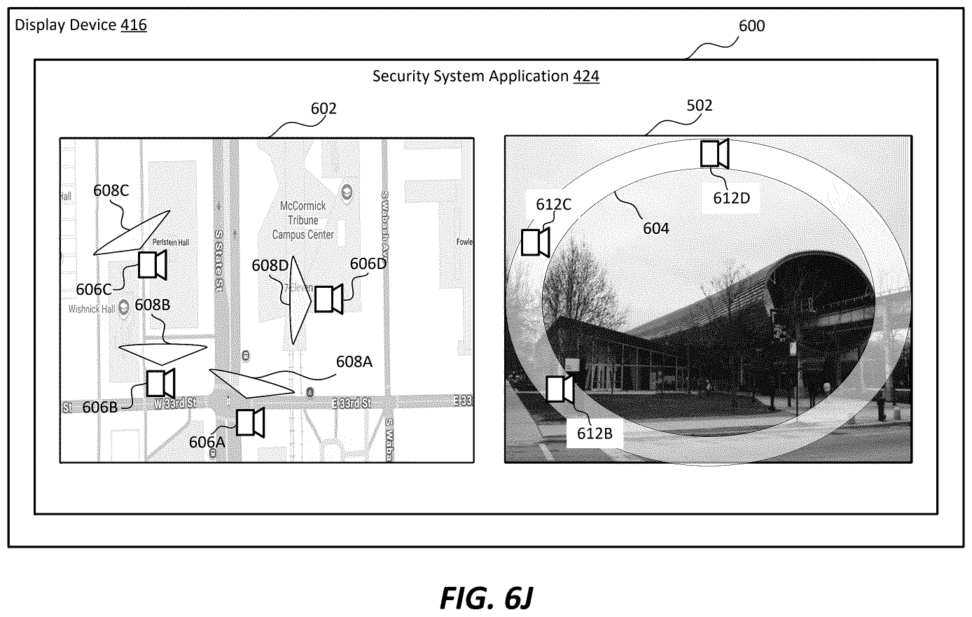

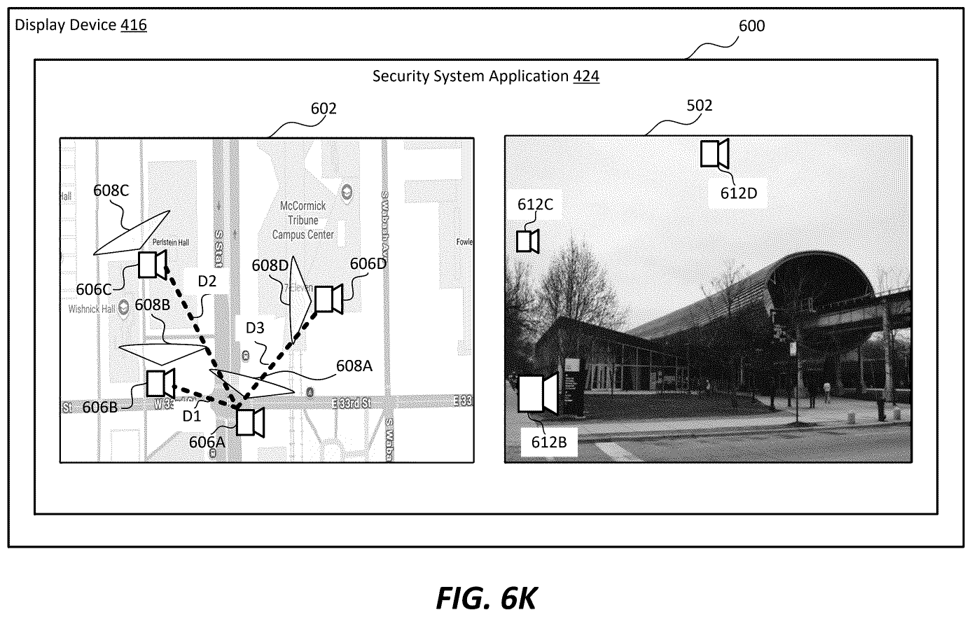

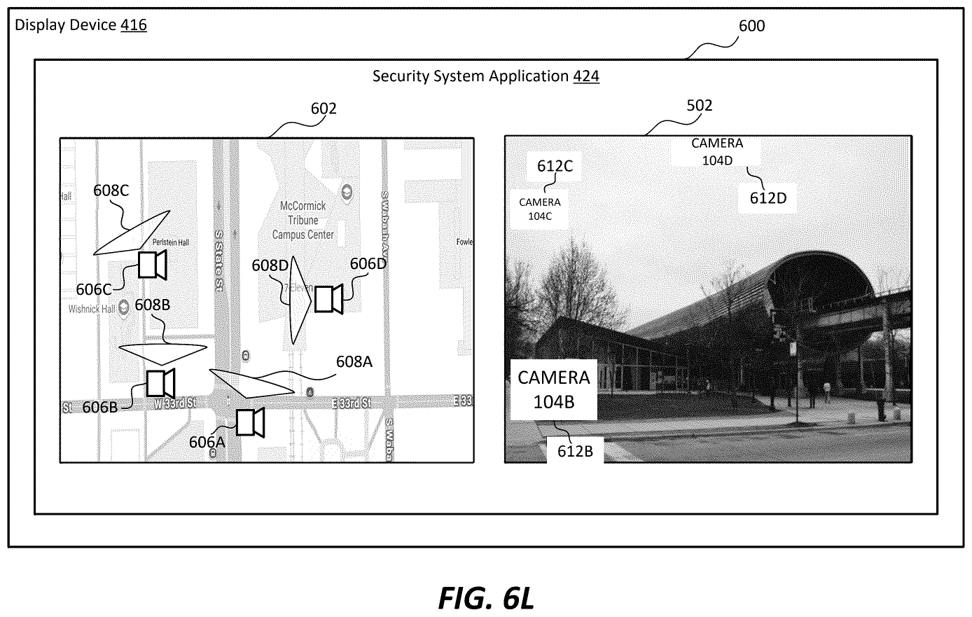

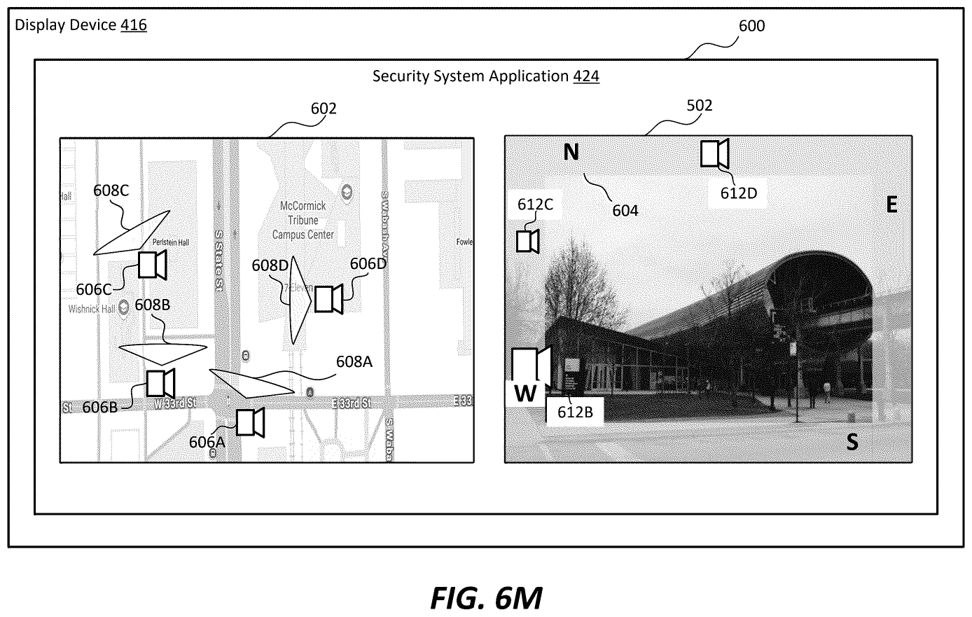

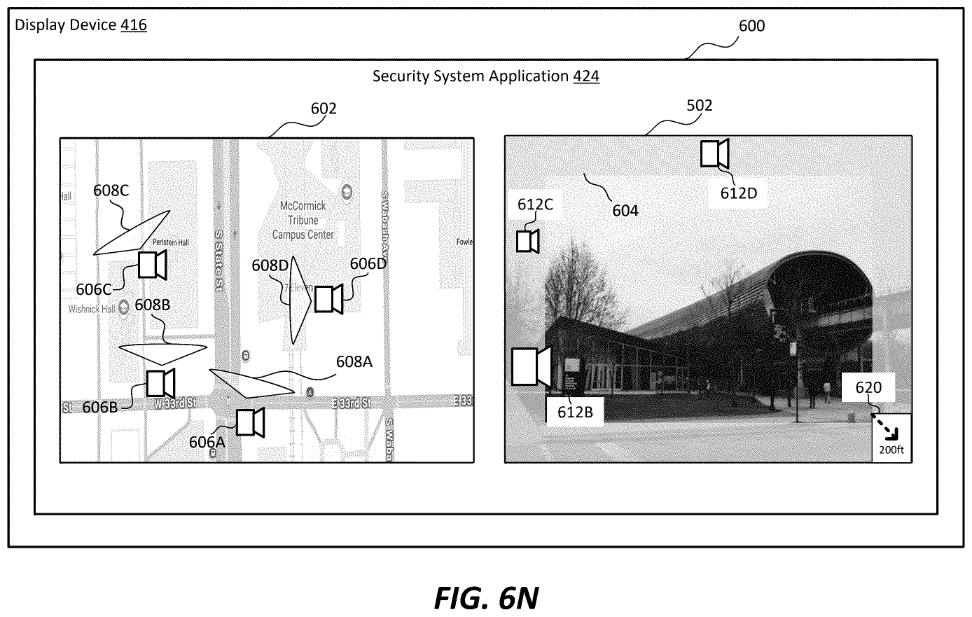

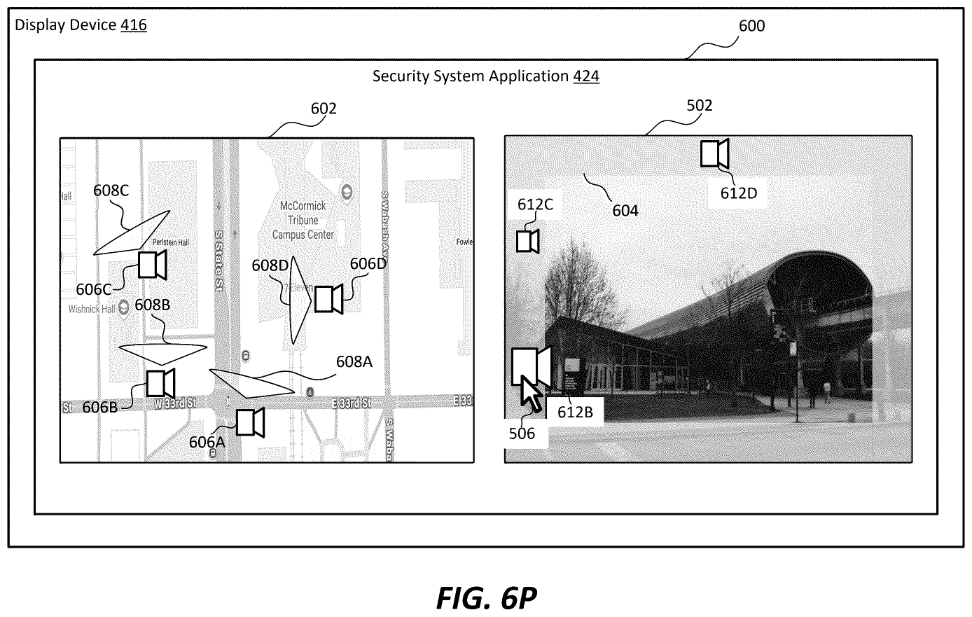

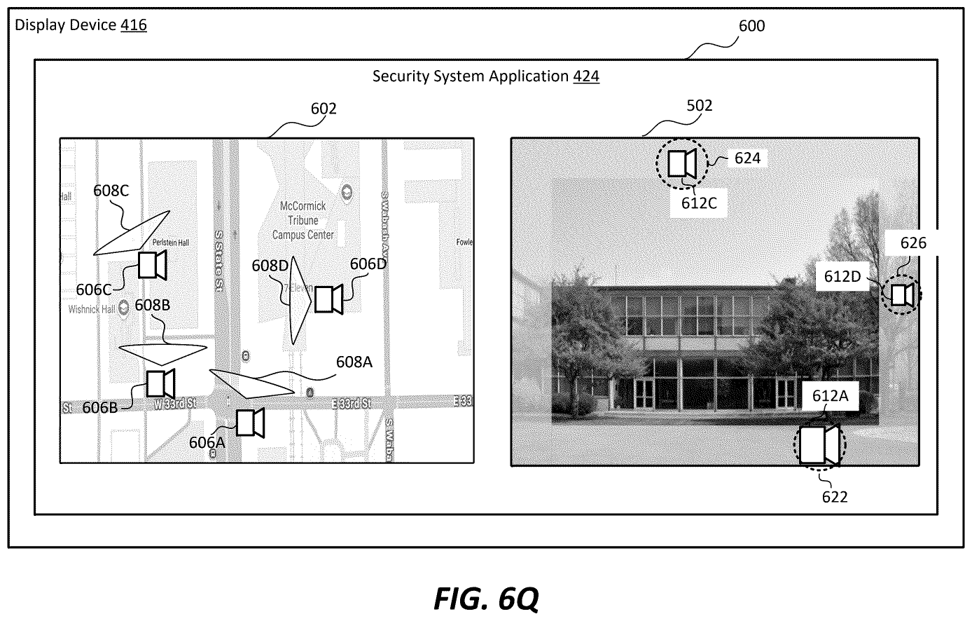

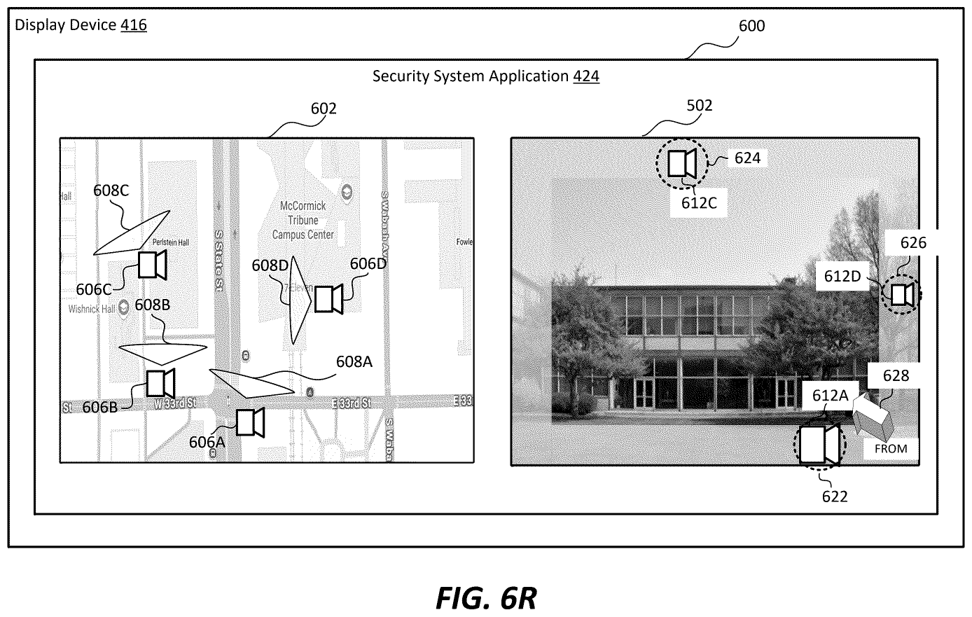

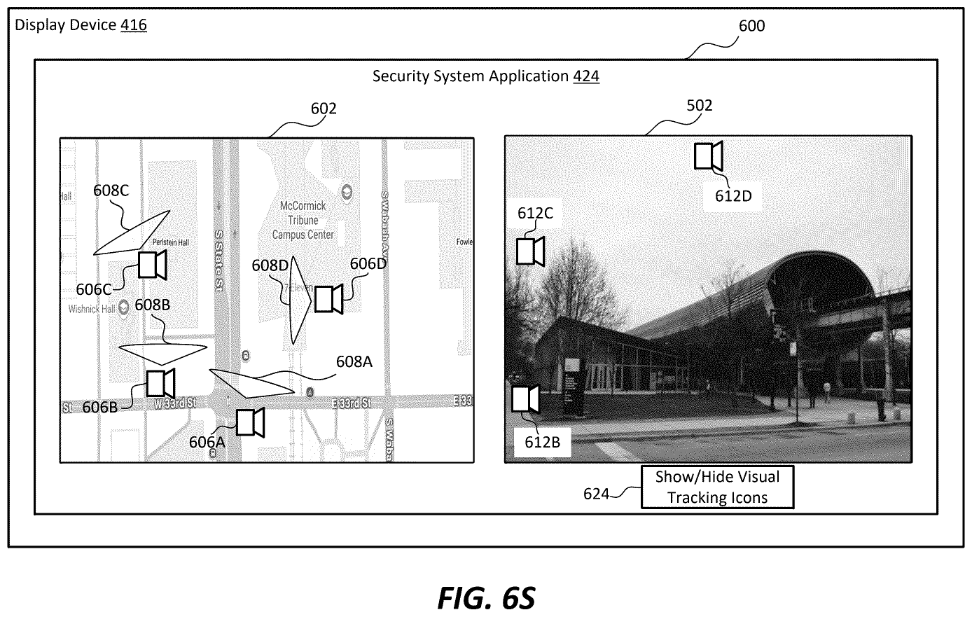

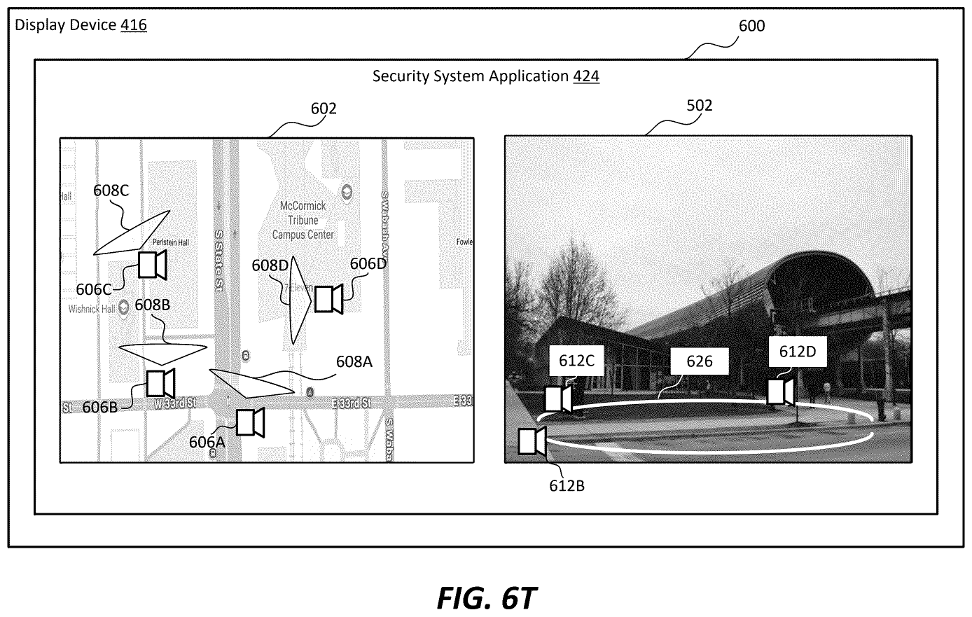

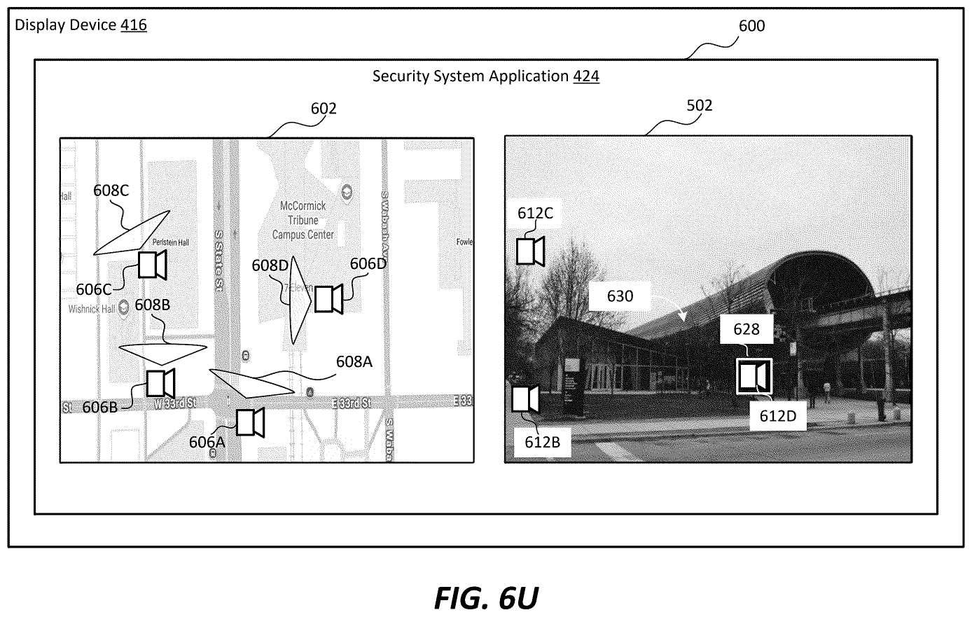

FIGS. 6A-6U illustrate an example graphical user interface 600 that is presented to a user for configuring security cameras 104 with visual tracking functionality, according to the present teachings. For example, FIGS. 6A-6U illustrate an example GUI 600 that is presented by the security system application 424 on the display device 416. As will be described in more detail herein, with the disclosed techniques, a user can interact with the GUI 600 of the security system application 424 to configure security cameras 104 with visual tracking functionality.

With reference to FIG. 6A, the GUI 600 includes a video tile 502 that can be used to display video data 318, or video feeds, generated by one or more security cameras 104. In the illustrated example of FIG. 6A, video data 318 generated by the security camera 104A is displayed within the video tile 502. In this example, the viewpoint of the security camera 104A (e.g., the physical angle and location from which the security camera 104A generates the video data displayed within the video tile 502) has not yet been configured with visual tracking functionality and/or calibrated with respect to the other nearby security cameras 104 included in the security system 100.

As further shown in FIG. 6A, the “Map View” option included in the menu 504 is selected using the cursor 506. Responsive to detecting a selection of the “Map View” option, as shown in FIG. 6B, the GUI 600 presents a map view portion 602 alongside the video tile 502. It should be noted that the map displayed in the map view portion 602 may be a georeferenced map (i.e., a map image associated with one or more geographic coordinates) or a non-georeferenced map (e.g., a floor plan, campus map, or the like).

In the illustrated example of FIG. 6B, a transparent border 604 is displayed around the outer perimeter of the video tile 502. In some examples, the transparent border 604 is displayed to provide an indication that the security camera 104A generating the video data displayed in the video tile 502 has not yet been configured with visual tracking functionality. In some examples, the transparent border 604 is displayed to provide an indication that the viewpoint of the security camera 104A generating the video data displayed in the video tile 502 has not yet been calibrated with respect to the other security cameras 104 included in the security system 100. In some examples, the transparent border 604 is displayed regardless of whether the security camera 104A generating the video data displayed in the video tile 502 has been configured with visual tracking functionality and/or the viewpoint of the security camera 104A generating the video data displayed in the video tile 502 has been calibrated with respect to the other security cameras 104 included in the security system 100. In some examples, a different shape and/or type of visual element may be displayed within the video tile 502 in place of the border 604. Moreover, in some examples, the transparent border 604 can be selectively enabled and disabled by a user.

The map view portion 602 displays a map of the area surrounding the security camera 104A. In some examples, the size of the area and/or map displayed within the map view portion 602 can be adjusted (e.g., expanded, shrunk, etc.) by a user. For example, the size of the map can be enlarged to include additional area surrounding the security camera 104A or minimized to reduce the area surrounding the security camera 104A.

Given that security camera 104A is installed at “Intersection A,” the map view portion 602 displays a two-dimensional map comprising the streets, buildings, and other structures located near the security camera 104A. However, in other examples, the map view portion 602 can display a different type of map. For example, for instances in which the security system 100 includes security cameras 104 installed within a building, the map view portion 602 may display a floor plan of the building and/or floors in which the security cameras 104 are installed. As another example, for instances in which the security system 100 includes security cameras 104 installed throughout various locations of an indoor/outdoor site, the map view portion 602 may display a map of the indoor/outdoor site at which the security cameras 104 are installed. As another example, for instances in which the security system is installed within a large open space, such as within a museum or in a stadium, the map view portion 602 may display a map of the area that includes landmarks such as seating sections, particular exhibits, and/or other types of landmarks.

As further shown in the illustrated example of FIG. 6B, the map view portion 602 includes a visual representation 606A of the security camera 104A. The visual representation 606A is displayed at a position within the map view portion 602 that corresponds to the physical location (e.g., Intersection A) at which the security camera 104A is installed. Furthermore, the map view portion 602 includes respective visual representations 606B-606D of the security cameras 104B-104D that are located nearby the security camera 104A. Similar to the visual representation 606A of security camera 104A, the visual representation 606B of the security camera 104B is displayed at a position within the map view portion 602 that corresponds to the physical location at which the security camera 104B is installed, the visual representation 606C of the security camera 104C is displayed at a position within the map view portion 602 that corresponds to the physical location at which the security camera 104C is installed, and the visual representation 606D of the security camera 104D is displayed at a position within the map view portion 602 that corresponds to the physical location at which the security camera 104D is installed.

In the illustrated example of FIG. 6B, visual representations 606B-606D of three security cameras 104B-104D located near security camera 104A are displayed within the map view portion 602. However, in other examples, more or fewer than three visual representations 606 of nearby security cameras 104 can be displayed within the map view portion 602. In some examples, the number (e.g., 1, 4, 5, 10, etc.) of visual representations 606 of security cameras 104 located near security camera 104A can be increased or decreased by the user. As further shown in the illustrated example of FIG. 6B, the visual representations 606A-606D of the security cameras 104A-104D are implemented as camera icons. However, in other examples, the visual representations 606A-606D can be implemented using text and/or other types of symbols.

In some examples, a visual representation of the viewpoint of a security camera 104 can also be displayed alongside the visual representation 606 of the security camera 104 within the map view portion 602. In such examples, the visual representation of the viewpoint (hereinafter referred to as “viewpoint visual representation”) provides an indication of the area that is captured by the viewpoint of the security camera 104. In other words, the viewpoint visual representation for a security camera 104 is displayed within the map view portion 602 to indicate the location and angle from which the security camera 104 generates video data. In some examples, the size of the viewpoint visual representation 606 is proportional to the view distance of the security camera 104 with which the viewpoint visual representation 606 is associated. In other examples, the size of the viewpoint representation 606 merely provides an indication of the viewpoint of the security camera 104 without providing an indication of the view distance of the security camera 104.

FIG. 6C illustrates an example in which respective viewpoint visual representations 608A-608D for the security cameras 104A-104D are displayed within the map view portion 602 alongside the visual representations 606A-606D of the security cameras 104A-104D. As shown, the viewpoint visual representation 608B is displayed in the map view portion 602 alongside the visual representation 606B of the security camera 104B to provide an indication of the angle and location from which the security camera 104B generates video data, the viewpoint visual representation 608C is displayed in the map view portion 602 alongside the visual representation 606C of the security camera 104C to provide an indication of the angle and location from which the security camera 104C generates video data, and the viewpoint visual representation 608D is displayed in the map view portion 602 alongside the visual representation 606D of the security camera 104D to provide an indication of the angle and location from which the security camera 104D generates video data. In the illustrated example of FIG. 6C, the viewpoint visual representation 608A for the security camera 104A is depicted as a question mark because the security camera 104A has not yet been configured with visual tracking functionality and/or the viewpoint of the security 104A has not yet been calibrated (e.g., information indicative of the viewpoint of the security camera 104A is not yet stored in the camera configuration data 320). By way of other examples, an uncalibrated security camera 104 may be identified by rendering the visual representation of the uncalibrated security camera 104 in a different color, with highlighting, shading, or the like.

As can be appreciated, the viewpoint visual representations 606A-606D displayed within the map view portion 602 help illustrate the relationships between the viewpoints of the security cameras 104A-104D. As described herein, in some examples, these relationships between viewpoints of the security cameras 104A-104D can be determined based on the camera configuration data 320, are implicitly defined in the camera configuration data 320, and/or explicitly defined in the camera configuration data 320. In some examples, the viewpoint visual representations 606A-606D are defined (e.g., via numerical or textual values, or the like) and/or drawn in the map view portion 602 by a user. In some examples, the security system application 424 automatically generates one or more of the viewpoint visual representations 606A-606D based on camera configuration data 320 stored in the security system server 106 and/or the security system computing device 108. In some examples, there are no viewpoint visual representations displayed within the map view portion 602. In some examples, the viewpoint visual representations 606A-606D can be selectively enabled and disabled by the user.

As described above with respect to the illustrated example of FIG. 6C, a question mark is used to depict the viewpoint visual representation 608A for security camera 104A because the security camera 104A has not yet been configured with visual tracking functionality and/or the viewpoint of the security camera 104 has not yet been calibrated. With the disclosed techniques, a user can interact with the map view portion 602 and the video tile 502 (which is displaying video data generated by the security camera 104A) to automatically configure the security camera 104A with visual tracking functionality. Moreover, with the disclosed techniques, a user can interact with the map view portion 602 and the video tile 502 (which is displaying video data generated by the security camera 104A) to calibrate the viewpoint of the security camera 104A with respect to the other security cameras 104.

With reference to FIG. 6D, a user can begin configuring visual tracking functionality for the security camera 104A by defining a relationship between the viewpoint of security camera 104A (e.g., as shown in the video data displayed within the video tile 502) and one of the other security camera 104 included in the security system 100. In some cases, the relationship is a spatial relationship, in which both the distance (real-world or relative distance) and the angle between the viewpoint of security camera 104A and the other security camera 104 is known. In some other cases, the relationship is a directional relationship, in which only the angle (i.e., the direction from one to the other) between security camera 104A and the other security camera 104 is known. In the illustrated example FIG. 6D, the user selects (e.g., using cursor 506) the visual representation 606B of the security camera 104B to define a directional and/or spatial relationship between the viewpoint of the security camera 104A and the location of the security camera 104B.

After selecting the visual representation 606B of security camera 104B, the user can then select a position, or space, within the video tile 502 that is indicative of the relationship between the security camera 104B and viewpoint of the security camera 104A. That is, because the video data displayed within the video tile 502 is captured from the viewpoint of the security camera 104A, the user can map the relationship between the security camera 104B and the viewpoint of the security camera 104A by selecting a space within the video tile 502 that corresponds to (e.g., is adjacent to, points in the direction of, etc.) the direction of the security camera 104B relative to the viewpoint of the security camera 104A. In the illustrated example of FIG. 6E, the user selects space 610 as the space within the video tile 502 that corresponds to the direction of the security camera 104B relative to the viewpoint of security camera 104A.

Although FIGS. 6D and 6E were described with respect to a user making a first selection of the visual representation 606B of security camera 104B and a second selection of space 610, in some examples, the two selections can be combined into a single user interaction (e.g., drag-and-drop with cursor 506) or divided into additional selections.

Responsive to detecting the user interaction(s) with the visual representation 606B of security camera 104B and the space 610 within the video tile 502 that corresponds to the direction of the security camera 104B relative to the viewpoint of security camera 104A, as shown in FIG. 6F, the security system application 424 causes the display of another visual representation 612B of the security camera 104B at space 610. The visual representation 612B of security camera 104B can be selected by the user (e.g., using cursor 506) to navigate to a video feed generated by security camera 104B. That is, the user can select and/or otherwise interact with the visual representation 612B of security camera 104B to display video data 318 generated by security camera 104B within the video tile 502. In that regard, a user can select the visual representation 612B of security camera 104B to visually track subjects that exit the video feed generated by security camera 104A near space 610 (e.g., near the space within the video tile 502 at which the visual representation 612B of security camera 104B is inserted).

In the illustrated example of FIG. 6F, the visual representation 612B of security camera 104B is displayed within the transparent border 604. However, for examples in which there is no transparent border 604, the visual representation 612B of security camera 104B is simply displayed at space 610 within the video tile 502. Moreover, although the visual representation 612B of security camera 104B is implemented as a camera icon in the illustrated example of FIG. 6F, in other examples, the visual representation 612B of security camera 104B can be implemented using text and/or one or more other types of symbols.

Further in response to detecting the user interaction(s) with the visual representation 606B of security camera 104B and the space 610 within the video tile 502 that corresponds to the direction and/or angle of the security camera 104B relative to the viewpoint of security camera 104A, as shown in FIG. 6G, the security system application 424 can update the camera configuration data 320 to reflect the calibrated viewpoint of the security camera 104A. For example, the security system application 424 can determine and/or update one or more orientation values (e.g., azimuth, bearing, map azimuth, etc.) associated with the security camera 104A in response to detecting the user interaction(s) with the visual representation 606B of security camera 104B and the space 610 within the video tile 502. Moreover, the security system application 424 can store these orientation values as camera configuration data 320 and automatically create, based in part on these orientation values, visual representations for security cameras 104C and 104D at the appropriate spaces within the transparent border 604 for security camera 104A.

For example, in response to updating the camera configuration data 320 based in part on the user interaction(s) with the visual representation 606B of security camera 104B and the space 610 within the video tile 502, the security system application 424 can automatically cause display of another visual representation 612C of security camera 104C at a space 614 within the video tile 502 that corresponds to the direction of the security camera 104C relative to the viewpoint of security camera 104A. The position of the space 614 within the video tile 502 can be determined, for example, based on the following camera configuration data 320: (i) the newly determined and/or updated orientation values associated with the security camera 104A and (ii) orientation information associated with the security camera 104C, or based on equivalent data not necessarily present in the camera configuration data 320, which may be derived from the known geographic or pixel coordinates of the security cameras 104A, 104C, 104D. Similar to the visual representation 612B of security camera 104B, the visual representation 612C of security camera 104C can be selected by the user (e.g., using cursor 506) to navigate to a video feed generated by security camera 104C. That is, the user can select and/or otherwise interact with the visual representation 612C of security camera 104C to display video data 318 generated by security camera 104C within the video tile 502, or within another video tile (for embodiments in which the GUI 600 comprises multiple video tiles). In that regard, a user can select the visual representation 612C of security camera 104C to visually track subjects that exit the video feed generated by security camera 104A near space 614 (e.g., near the space within the video tile 502 at which the visual representation 612C of security camera 104C is inserted).

As another example, in response to updating the camera configuration data 320 based in part on the user interaction(s) with the visual representation 606B of security camera 104B and the space 610 within the video tile 502, the security system application can 424 can automatically cause display of another visual representation 612D of security camera 104D at a space 616 within the video tile 502 that corresponds to the direction of the security camera 104D relative to the viewpoint of security camera 104A. The position of the space 616 within the video tile 502 can be determined, for example, based on the following camera configuration data 320: (i) the newly determined and/or updated orientation values associated with the security camera 104A and (ii) orientation information associated with the security camera 104D. Similar to the visual representation 612B of security camera 104B, the visual representation 612D of security camera 104D can be selected by the user (e.g., using cursor 506) to navigate to a video feed generated by security camera 104D. That is, the user can select and/or otherwise interact with the visual representation 612D of security camera 104D to display video data 318 generated by security camera 104D within the video tile 502. In that regard, a user can select the visual representation 612D of security camera 104D to visually track subjects that exit the video feed generated by security camera 104A near space 616 (e.g., near the space within the video tile 502 at which the visual representation 612D of security camera 104CD is inserted).

In some examples, before rendering the visual representations 612C 612D of security cameras 104C and 104D at the respective spaces 614 and 616 in the video tile, the security system application 424 can first prompt (e.g., via a pop-up window or some other suitable means) a user to confirm that the visual representation 612B of security camera 104B is properly positioned at the space 610 within the video tile 502. In such examples, responsive to the user confirming that the visual representation 612B of security camera 104B is properly positioned at the space 610 within the video tile 502, the security system application 424 can then render the visual representation 612C of the security camera 104C at space 614 and/or the visual representation 612D of the security camera 104D at space 616. In some examples, the visual representations 606C and 606D of the security cameras 104C and 104D can be rendered with a transparent effect, a greyed-out effect, or the like, to indicate that these are the other visual representations 612C and 612D of the security cameras 104C and 104D will be rendered in the video tile 502 following confirmation of the visual representation 612B of the security camera 104B (e.g., whether by simply finishing the drag-and-drop or by hitting a confirmation button).

As also described herein, in some examples, the camera configuration data 320 can include data that is indicative of and/or data that explicitly defines the relationships between the respective viewpoints of security cameras 104 included in the security system 100. For example, the camera configuration data 320 can include data indicative of a previously established (e.g., using the disclosed techniques) relationship between the respective viewpoints of the security cameras 104B and 104C. In such examples, based on (i) this previously established relationship between the respective viewpoints of the security cameras 104B and 104C and (ii) the newly established (e.g., via the user selections shown in FIGS. 6D and 6E) relationship between the viewpoint of security camera 104A and the security camera 104B, the security system application 424 can automatically determine a relationship between the security camera 104C and the viewpoint of security camera 104A. Then, based on the relationship between the security camera 104C and the viewpoint of security camera 104A, the security system application 424 can automatically determine the space 614 within the video tile 502 that corresponds to the direction/angle of the security camera 104C relative to the viewpoint of security camera 104A. Moreover, as shown in FIG. 6G, the security system application 424 can cause the display of the visual representation 612C of security camera 104C at space 614.

As another example, the camera configuration data 320 can include data indicative of a previously established (e.g., using the disclosed techniques) relationship between the respective viewpoints of the security cameras 104B and 104D. In this example, based on (i) this previously established relationship between the respective viewpoints of the security cameras 104B and 104D and (ii) the newly established (e.g., via the user selections shown in FIGS. 6D and 6E) relationship between the security camera 104B and the viewpoint of security camera 104A, the security system application 424 can automatically determine a relationship between the security camera 104D and the viewpoint of security camera 104A. Then, based on the relationship between the security camera 104D and the viewpoint of security camera 104A, the security system application 424 can automatically determine the space 616 within the video tile 502 that corresponds to the direction of the security camera 104D relative to the viewpoint of security camera 104A. Moreover, as shown in FIG. 6G, the security system application 424 can cause the display of the visual representation 612D of security camera 104D at space 616.

FIG. 6H illustrates an example in which visual tracking functionality has been configured for the security camera 104A. As shown in FIG. 6H and described above, within the video tile 502 that is displaying video content generated by security camera 104A, the visual representation 612B of security camera 104B, which can be selected by a user to navigate to a video feed generated by security camera 104B, is inserted at a space within the video tile 502 that corresponds to the direction of security camera 104B relative to the viewpoint of security camera 104A. Moreover, within the video tile 502 that is displaying video content generated by security camera 104A, the visual representation 612C of security camera 104C, which can be selected by a user to navigate to a video feed generated by security camera 104C, is inserted at a space within the video tile 502 that corresponds to the location and/or viewpoint of security camera 104C relative to the viewpoint of security camera 104A. Similarly, within the video tile 502 that is displaying video content generated by security camera 104A, the visual representation 612D of security camera 104D, which can be selected by a user to navigate to a video feed generated by security camera 104D, is inserted at a space within the video tile 502 that corresponds to the location and/or viewpoint of security camera 104D relative to the viewpoint of security camera 104A.

Persons skilled in the art should understand that although only three visual representations 612B-612D of security cameras 104B-104C are inserted within the video tile 502 in the illustrated examples of FIG. 6H, in other examples, more or fewer than three visual representations 612 of nearby security cameras 104 can be inserted in the video tile 502. In some examples, the number (e.g., 1, 4, 5, 10, etc.) of visual representations 612 of security cameras 104 inserted in the video tile 502 can be increased or decreased by the user. Moreover, although the visual representations 612B-612D of security cameras 104B-104D are implemented as camera icons in the illustrated example of FIG. 6H, in other examples, the visual representations 612B-612D can be implemented using text and/or other types of symbols. Additionally, in some embodiments, the orientation of the visual representations 612B-612D of security cameras 104B-104D (i.e., the orientation of the camera icons) may be varied as a function of the viewpoint of the security cameras 104B-104D. For instance, if the security camera 104B has a viewpoint facing west, the camera icon associated with security camera 104B may be rotated to align to the left, or to align with an appropriate direction indicative of west from the viewpoint of the security camera 104A.

Furthermore, in the illustrated example of FIG. 6H, each of the visual representations 612B-612D are displayed within the transparent border 604 in the video tile 502. However, as described herein, in some examples, there is no transparent border 604 displayed within the video tile 502 and/or the transparent border 604 is removed from the video tile 502 once a security camera 104 is configured with visual tracking functionality. In that regard, because security camera 104A has been configured with visual tracking functionality, in some examples, the transparent border 604 is no longer displayed within the video tile 502. FIG. 6I illustrates an example in which the visual representations 612B-612D of security cameras 104B-104D are inserted in the video tile 502 without a transparent border 604.

As also described herein, in some examples, the transparent border 604 can be implemented with shapes and/or styles other than the rectangular shape and style shown in FIG. 6H. For example, as shown in FIG. 6J, the transparent border 604 can be ring shaped. However, persons skilled in the art should understand that the ring and rectangular shaped transparent borders 604 are just a few non-limiting examples of visual elements that can be added to the video tile 502. Moreover, persons skilled in the art should understand that, in some examples, the visual representations 612B-612D of security cameras 104B-104C can be displayed within one or more visual elements other than the transparent borders 604 described herein. By way of one non-limiting example, one or more circle arcs may be disposed within the video tile 502, for instance in a ground plane of the video feed, and the one or more visual representations 612B-612D may be disposed along the one or more circle arcs. This may be useful, for instance, in order to provide a sense of perspective or immersion to the user viewing the video feed provided by the camera 104A and displayed in the video tile 502.

Although the visual representation 612B of security camera 104B is inserted within the video tile 502 at the space 610 that corresponds to the location and/or viewpoint of security camera 104B relative to the viewpoint of security camera 104A, the visual representation 612B shown in the illustrated examples of FIGS. 6H-6J does not necessarily indicate the relative distance between security cameras 104A and 104B. Similarly, the visual representation 612C of security camera 104C inserted at space 614 does not necessarily indicate the relative distance between security cameras 104A and 104C, and the visual representation 612D of security camera 104D inserted at space 616 does not necessarily indicate the relative distance between security cameras 104A and 104D. However, in some instances, it may be useful for a user to have insight into how far away a particular security camera 104B-104D is from security 104A while visually tracking a subject moving through the video feed generated by security camera 104A. In that regard, in some examples, the security system application 424 can apply one or more visual effects to the visual representations 612B-612D of security cameras 104B-104D that indicate the respective distances between the locations and/or viewpoints of security cameras 104B-104D and the location and/or viewpoint of security camera 104A.

FIG. 6K illustrates an example in which the security system application 424 adjusts the size of the visual representations 612B-612D according to the respective distances between the locations and/or viewpoints of security cameras 104B-104D and the location and/or viewpoint of security camera 104A. In the illustrated example of FIG. 6K, the security system application 424 increases the size of visual representations 612 of security cameras 104 that are closer to the security camera 104A and decreases the size of visual representations 612 of security cameras 104 that are further from the security camera 104A.

For example, as shown in the map view portion 602, the distance D1 between the viewpoint and/or location of security camera 104A and the viewpoint and/or location of security camera 104B is smaller than the (i) distance D2 between the viewpoint and/or location of security camera 104A and the viewpoint and/or location of security camera 104C and (ii) the distance D3 between the viewpoint and/or location of security camera 104A and the viewpoint and/or location of security camera 104D. In that regard, the security system application 424 makes the size of visual representation 612B of security camera 104 larger than the respective sizes of the visual representations 612C and 612D of security cameras 104C and 104D. As further shown in the map view portion 602, the distance D2 between the viewpoint and/or location of security camera 104A and the viewpoint and/or location of security camera 104C is larger than the distance D3 between the viewpoint and/or location of security camera 104A and the viewpoint and/or location of security camera 104D. Accordingly, in this example, the security system application 424 can make the size of visual representation 612C of security camera 104C smaller than the size of the visual representation 612D of security camera 104D. Therefore, the size of the visual representation 612B of security camera 104B is made the largest and the size of the visual representation 612C of security camera 104C is made the smallest.

Persons skilled in the art should understand that adjusting the size of the visual representation 612 of a security camera 104 is just one non-limiting example of a visual effect that can be applied by the security system application 424 to provide an indication of a distance to a viewpoint and/or location of a security camera 104. Moreover, in other examples, one or more other types of visual effects can be applied to the visual representations 612 of the security cameras 104. For example, the security system application 424 can adjust a z-axis value, or rendering height, (e.g., increase or decrease) of a visual representation 612 of a security camera 104 to indicate a relative distance to the location and/or viewpoint of the security camera 104. In some examples, adjusting the rendering height of a visual representation 612 of a first security camera 104 includes overlapping the visual representation 612 of a second security camera 104 with the visual representation 612 of the first security camera 104 to indicate that the first security camera 104 is closer. As another example, the security system application 424 can adjust a transparency (e.g., increased transparency for further, decreased transparency for closer) of a visual representation 612 of a security camera 104 based on a distance to the location and/or viewpoint of the security camera 104. As another example, the security system application 424 can adjust a fill color (e.g., green for closer, red for further) of a visual representation 612 of a security camera 104 based on a distance to the location and/or viewpoint of the security camera 104. As another example, the security system application 424 can adjust a fill pattern of a visual representation 612 of a security camera 104 based on a distance to the location and/or viewpoint of the security camera 104. As another example, the security system application 424 can insert a distance value (e.g., as a number and/or text) next to a visual representation 612 of a security camera 104 to indicate a distance to the location and/or viewpoint of the security camera 104. In some examples, the security system application 424 can apply a glow effect and/or similar visual effect (e.g., bold, italics, etc.) to a visual representation 612 of a security camera 104 to indicate a short distance to the location and/or viewpoint of the security camera 104. In some examples, one or more other visual effects can be used to indicate distance to the viewpoint and/or location of a security camera 104.

Although the visual representations 612B-612D of security cameras 104B-104D have been described herein and illustrated as camera icons, in some examples, the visual representations 612B-612D can be implemented using text and/or other types of symbols. FIG. 6L illustrates an example in which the visual representations 612B-612D of security cameras 104B-104D are implemented using text to identify the security cameras 104B-104D. As also shown in the illustrated example of FIG. 6L, the respective sizes of the text visual representations 612B-612D correspond to the distances between the viewpoints and/or locations of security cameras 104B-104D and the viewpoint of security camera 104A.

In some examples, one or more other types of information can be added to the video tile 502 when configuring a security camera 104 with visual tracking functionality. For example, as shown in FIG. 6M, indications of direction relative to the viewpoint of security camera 104A can be added to the video tile 502 to assist with visual tracking functionality. In the illustrated example of FIG. 6M, an “N” is added to the video tile 502 to indicate true north relative to the viewpoint of security camera 104A, an “E” is added to the video tile 502 to indicate which direction is east relative to the viewpoint of security camera 104A, an “S” is added to the video tile 502 to indicate which direction is south relative to the viewpoint of security camera 104A, and a “W” is added to the video tile 502 to indicate which direction is west relative to the viewpoint of security camera 104A. The security system application 424 can automatically determine directional information relative to the viewpoint of security camera 104A using at least the camera configuration data 320 (e.g., the azimuth or bearing of the camera 104A); in some cases, a reference direction may be used in conjunction with the camera configuration data 320. In some examples, one or more other types of information (e.g., numerical degrees) can be added to the video tile 502 to indicate direction relative to the viewpoint of security camera 104A.

As described herein, in some examples, the distance range for nearby security cameras 104 that are represented within a video feed with visual representations 612 can be adjusted by a user. For example, a user may choose to see visual representations 612 of security cameras 104 that are located within 100 feet, 200 feet, 300 feet, and/or some other distance of the security camera 104 generating the video feed being displayed within the video tile 502. In that regard, in some examples, the security system application 424 can add a visual indication of the current max distance range for security cameras 104 that are represented with visual representations 612 within the video tile 502.

FIG. 6N illustrates an example in which a visual indication 620 is added to the lower right corner of the video tile 502 to indicate that visual representations 612B-612D of security cameras 104B-104D within 200 feet of security camera 104A are currently inserted in the video feed portion for use with visual tracking. In this example, the user can interact with the visual indication 620 (e.g., using cursor 506) and/or use some other mechanism (e.g., a menu option, a hotkey, etc.) to adjust the max range for security cameras 104 that can be added to the video tile 502 (e.g., added via visual representations 612 of the security cameras 104). In some examples, other approaches for “filtering” which nearby security cameras 104 are represented with visual representations 612 can be used. For instance, security cameras 104 from adjacent rooms may be represented using visual representations 612, security cameras 104 on the same floor can be represented using visual representations 612, visual representations 612 of security cameras 104 located in a room of particular importance (e.g., security room, main lobby, etc.) may always be shown, and the like.

In some examples, one or more security cameras 104 can be grouped together based on predetermined distance thresholds, for instance associated with the distances through which a user can cycle by interacting with the visual indication 620. For example, in a case in which three distances are selectable via the visual indication 620 (e.g., 50, 100, and 200 ft), the security cameras 104 may be grouped into three sets: cameras within 50 ft, cameras within 50 to 100 ft, and cameras within 100 to 200 ft. Cycling from one group to another may be termed a “hop.” In that regard, a user can “hop” between the groups of the security cameras 104 by interacting with the visual indication 620. For example, a user can “hop” from the group of security cameras 104 within 50 ft to the group of security cameras 104 within 50 to 100 ft by selecting the visual indication 620 once. As another example, a user can “hop” from the group of security cameras 104 within 50 ft to the group of security cameras 104 within 100 to 200 ft by selecting the visual indication 620 twice.

As described herein, a visual representation 612 of a security camera 104 displayed within the video tile 502 can be selected and/or otherwise interacted with by a user to navigate to the video feed generated by that security camera 104. For example, as shown in FIG. 6P, a user can select (e.g., using cursor 506) the visual representation 612B of security camera 104B to navigate to the video feed generated by security camera 104. In some instances, a user may choose to navigate to the video feed generated by security camera 104B because a subject appearing in the video feed generated by security camera 104A is exiting the video tile 502 proximate the visual representation 612B of security camera 104B.

In response to detecting the user selection and/or interaction with the visual representation 612B of security camera 104B, the security system application 424 can cause the display of a video feed generated by security camera 104B within the video tile 502. FIG. 6Q illustrates an example in which a video feed generated by the security camera 104B is displayed within the video tile 502. It should be noted, however, that in examples in which the GUI 600 provides multiple video tiles, the video tile 502 may continue to display the video feed produced by the security camera 104A, and may cause display of the video feed produced by the security camera 104B in a second, separate video tile. As further shown in FIG. 6Q, visual representations 612A, 612C, and 612D of the security cameras 104A, 104C, and 104D are displayed within the video tile 502. With the disclosed techniques, the security system application 424 automatically causes the display of a visual representation 612 of a security camera 104 at a space within the video tile 502 that corresponds to the location and/or viewpoint of the security camera 104 relative to the viewpoint of security camera 104B.

For example, the security system application 424 can automatically determine a space 622 within the video tile 502 that corresponds to the location and/or viewpoint of the security camera 104A relative to the viewpoint of security camera 104B based on information included in the camera configuration data 320. Moreover, the security system application 424 can then cause the display of the visual representation 612A of security camera 104A at the space 622. In accordance with techniques described herein, the visual representation 612A of security camera 104A can then be selected and/or otherwise interacted with by a user to navigate to a video feed generated by security camera 104A.

As another example, the security system application 424 can automatically determine a space 624 within the video tile 502 that corresponds to the location and/or viewpoint of the security camera 104C relative to the viewpoint of security camera 104B based on information included in the camera configuration data 320. Moreover, the security system application 424 can then cause the display of the visual representation 612C of security camera 104C at the space 624. In accordance with techniques described herein, the visual representation 612C of security camera 104C can then be selected and/or otherwise interacted with by a user to navigate to a video feed generated by security camera 104C.

Similarly, the security system application 424 can automatically determine a space 626 within the video tile 502 that corresponds to the location and/or viewpoint of the security camera 104D relative to the viewpoint of security camera 104B based on information included in the camera configuration data 320. Moreover, the security system application 424 can then cause the display of the visual representation 612D of security camera 104D at the space 626. In accordance with techniques described herein, the visual representation 612D of security camera 104D can then be selected and/or otherwise interacted with by a user to navigate to a video feed generated by security camera 104D. It will be understood that the display of the visual representations 612A, 612C, and 612D at respective locations 622, 624, 626 may occur substantially concomitantly.

In some examples, it may be useful for a user to know which video feed and/or area relative to the current video feed they last navigated from. For example, it may be useful for a user viewing video data generated by security camera 104B and displayed in video tile 502 that the previously viewed video feed was generated by security camera 104A and/or is associated with an area southeast of the video feed generated by security camera 104B. In that regard, the security system application 424 can cause display of a visual indication of the direction from which the user navigated to the video feed generated by security camera 104B. FIG. 6R illustrates an example in which an arrow 628 is inserted in the video tile 502 to indicate a direction and/or location from which a user navigated to the video feed generated by security camera 104B. In another example, a navigation element, for instance composed of two opposing arrows, may be overlayed in the video tile 502; a user may interact with the arrows to go back to a previous video feed or forward to a video feed which was viewed following viewing of a current video feed. Other approaches are also considered.

In the illustrated examples of FIGS. 6A-6R, the security cameras 104A-104D are described and illustrated as being located within different buildings, at different intersections and/or street corners, and/or otherwise distributed about an area of a city being monitored by security system 100. However, as described herein, in some examples, multiple security cameras 104 may be located nearby within the same space (e.g., a room of a building, in the same hallway, on the same floor, etc.). For instance, a museum may have very large rooms in each of which are installed multiple security cameras 104.

In such examples, when seeking to visually track a subject through video feeds generated by the security cameras 104, it may not be pertinent for a user to navigate between security cameras 104 located within the same space, even if the security cameras 104 are nearby. Therefore, in some examples, to indicate which security cameras 104 are located within the same space as the security camera 104 that is generating the video feed displayed within video tile 502, the security system application 424 can apply a particular visual effect to the visual representations 612 of said security cameras 104 located within the same space. For example, the security system application 424 can apply one or more of the visual effects described herein (e.g., change the color, add a glow, change the fill pattern, change the transparency, etc.) to visual representations 612 of security cameras 104 located within the same space as the security camera 104 generating the video feed displayed within the video tile 502.

In some examples, the security system application 424 allows for a user to selectively hide visual representations 612 of security cameras 104 located within the same space as the security camera 104 generating the video feed displayed within the video tile 502, for instance via a selectable element in the menu 504. Additionally, in some embodiments, it may be possible, for instance via a selectable element in the menu 504, to selectively activate or hide the visual representations 612 of the security cameras 104 as a whole (i.e., to turn off the visual tracking links). FIG. 6S illustrates an example in which a selectable element 624 enables a user to selectively hide and/or show the visual representations 612 of the security cameras 104. Alternatively, or in addition, the selectable element 624 of the security system application 424 may cause the visual representations 612 of the security cameras 104 to be displayed only in response to a user interaction a particular video tile (e.g., hovering over a tile, clicking in a tile, etc.).

As described herein, in some examples, one or more circle arcs can be disposed within the video tile 502, for instance in a ground plane of the video feed. FIG. 6T illustrates an example in which one or more visual representations 612B-612D are positioned along one or more circle arcs 626 disposed in the ground plane of the video feed. This may be useful, for instance, in order to provide a sense of perspective or immersion to the user viewing the video feed provided by the camera 104A and displayed in the video tile 502.

In some examples, a visual representation 612 of a security camera 104 can be anchored to a location within the video tile 502, thereby facilitating a logical association between the security camera 104 and the object appearing at that location in the video feed displayed in the video tile 502. For instance, in one non-limiting example, a visual representation 612 of a security camera 104 located on the other side of a door depicted in a video feed may be anchored with a portion of the video tile 502 where the door is depicted. In this fashion, an operator can understand that by interacting with the visual representation of the security camera 104 disposed on the door, the operator can navigate to a video feed generated by a security camera 104 that is physically located (e.g., in the real world) on the other side of the door. Other examples can also be considered.

In some examples, logical anchoring of a visual representation 612 of a security camera 104 may be performed via a configuration mode. As an example, a configuration mode can be instantiated in response to receiving a suitable user input, for instance as described elsewhere herein. In some examples, instantiation of the configuration mode causes the transparent border 604 in which the visual representations 612 of the security cameras 104 are located to be made visible. Then, while security system application 424 is in a configuration mode, a user input indicative of a selection of a particular one of the visual representations 612 is received, and thereafter an additional user input indicative of a space within the video tile 502 is received (though in some cases, this may be a single input operation, such as a drag-and-drop operation). The security system application 424 then associates the visual representation 612 of the security camera 104 with the space, such that even as the video feed displayed within the video tile 502 changes, the visual representation 612 of the security camera 104 remains at the same space in the video tile 502.

FIG. 6U illustrates an example in which the visual representation 612D of the security camera 104D is logically anchored to the location within video tile 502 that corresponds to the door 628 of building 630, thereby indicating to a user viewing the video feed generated by the security camera 104A that the security camera 104D is disposed on the other side of the door 628 and inside the building 630.

For cases in which the security camera 104 producing the video feed displayed in the video tile 502 is a PTZ or otherwise movable camera, the visual representation 612 of the security camera 104 can move within the video tile 502 to follow the object (e.g., a door) to which the visual representation 612 of the security camera 104 was logically anchored. In some examples, various analytics may be employed by the security system application 424 to identify and follow an object (e.g., edge detection, object recognition, etc.). In some other examples, the security system application 424 can determine a displacement of the object based on one or more of an amount of rotation of the security camera 104, an estimated or perceived distance between the security camera 104 and the object, and/or some other information associated with movement of the security camera 104. When the object leaves the field of view of the security camera 104 (e.g., is no longer visible in the video feed displayed within the video tile 502), the security system application 424 can cause the visual representation 612 of the security camera 104 to disappear (e.g., rendering of the visual representation 612 stops) or move to an edge of the video tile 502. In some examples, the above operations can be performed during normal operation of the security system application 424, without the need to enter a configuration mode.

In some examples, the visual representations 612 of a given security camera 104 are independent of one another. That is to say, if the visual representation 612B of security camera 104B is logically anchored to a location and/or an object in the video tile 502 when a video feed generated by the security camera 104A is displayed within the video tile 502, the visual representation 612B of security camera 104B may not necessarily be logically anchored to that location and/or object in the video tile 502 when the video tile 502 displays video feeds generated by security cameras 104C or 104D.

In other examples, the logical anchoring of visual representations 612 of a security camera 104 can be applied to video tiles 502 displaying video feeds generated by multiple other security cameras 104. For example, if the visual representation 612B of security camera 104B is logically anchored to a door appearing in the video feed that is displayed in video tile 502 and generated by security camera 104A, the security system application 424 can (i) reidentify that door in the video feeds generated by security cameras 104C and 104D and (ii) cause the visual representation 612B of security camera 104B to be logically anchored to the same door when the video tile 502 is displaying the video feeds generated by security cameras 104C and 104D. By way of another example, the security system application 424 can determine a real-world position for the door (e.g., based on known GPS location of the security camera 104A, a distance of the security camera 104A to the door, etc.) and cause the visual representation 612B of security camera 104B to be anchored to the real-world position of the door as seen by security cameras 104C and 104D when the video tile 502 displays the video feeds generated by security cameras 104C and 104D. Other approaches for sharing visual anchoring across cameras are also considered.

In the illustrated examples of FIGS. 6A-6U, configuring a security camera 104 with visual tracking functionality is shown and described with respect to a GUI 600 that includes a video tile 502 and a map view portion 602. However, in some examples, a GUI for configuring a security camera 104 with visual tracking functionality that does not include a map view portion can be presented by the security system application 424 on the display device 416.

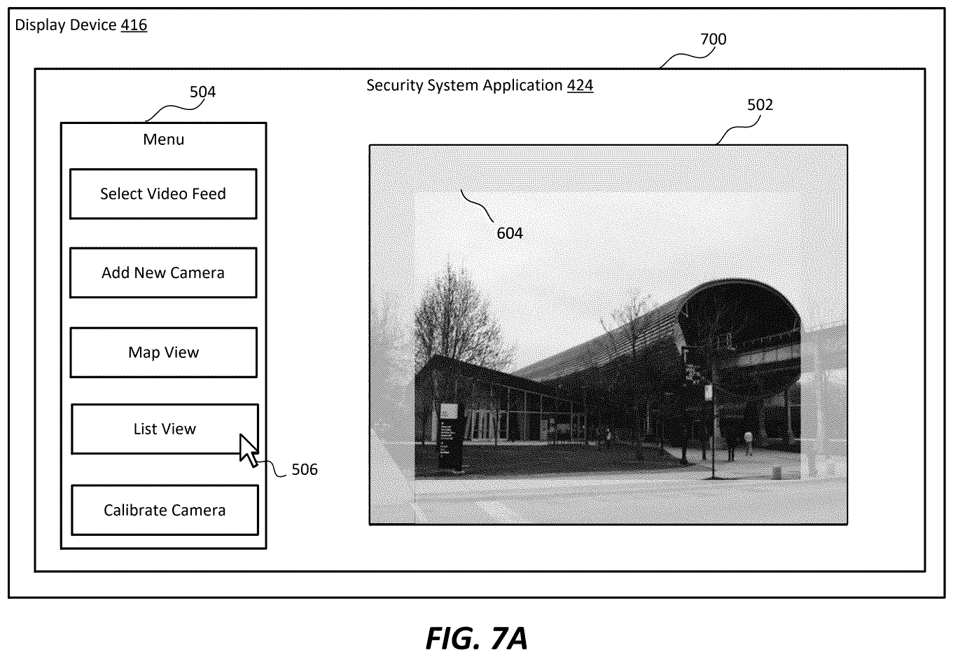

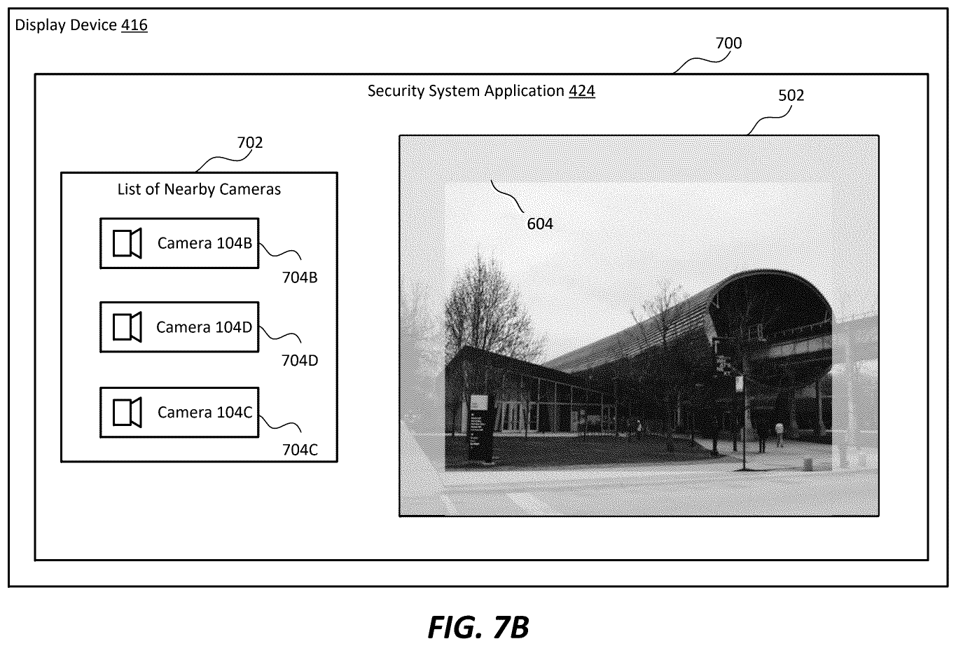

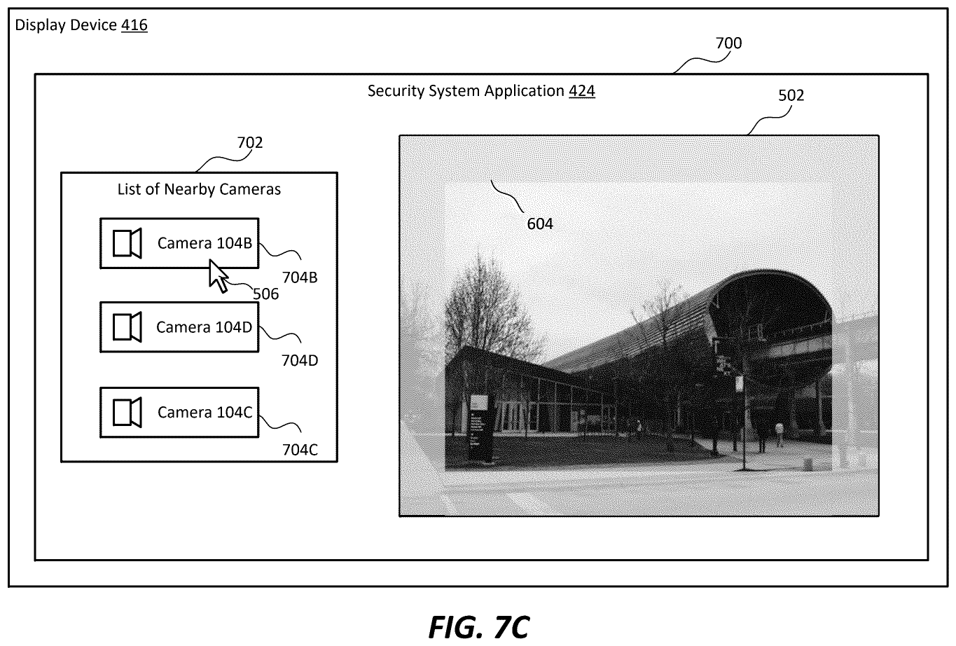

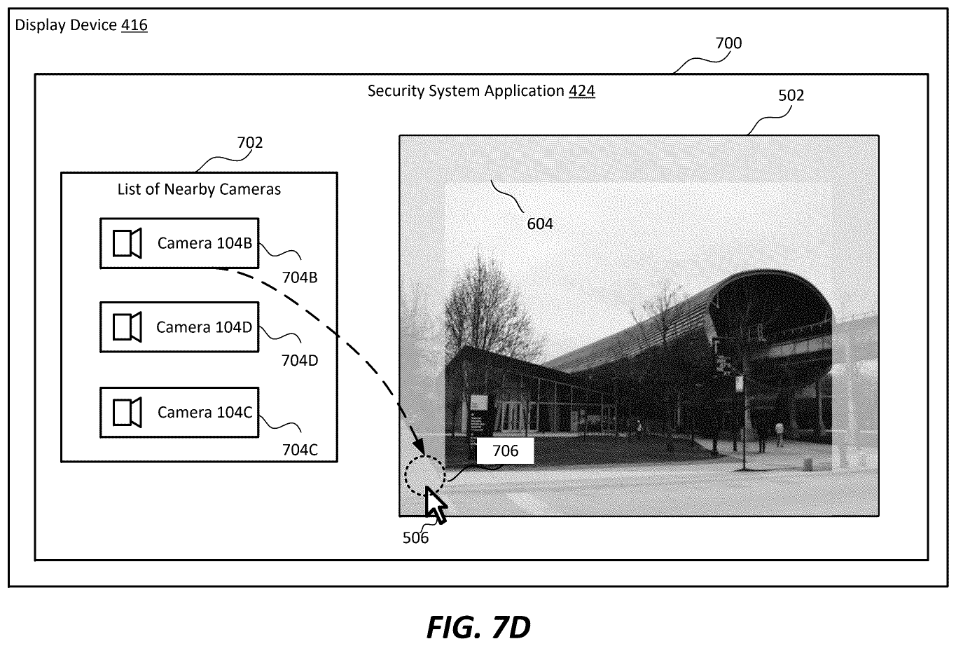

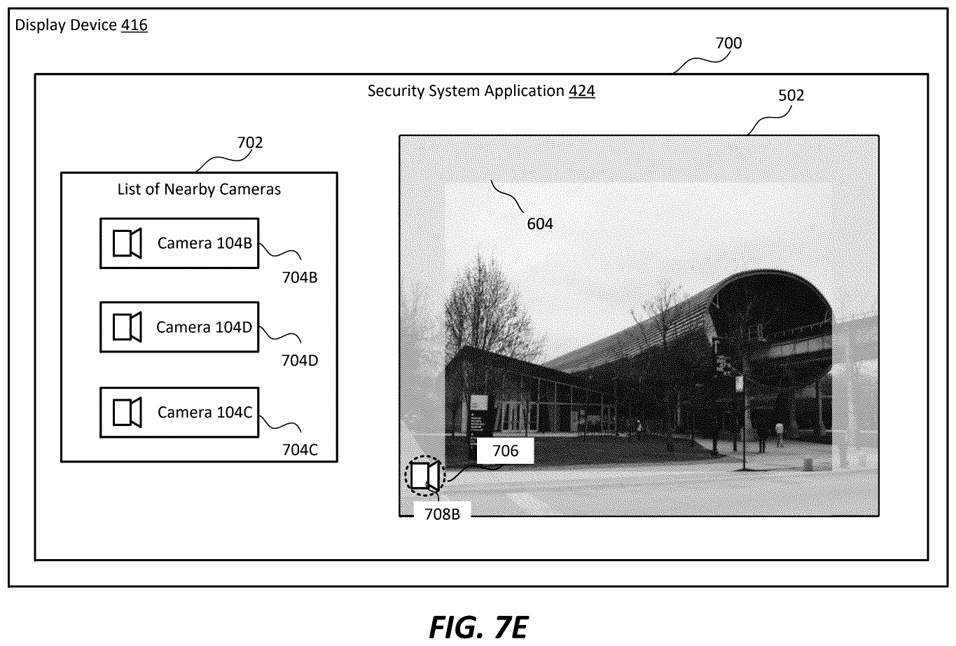

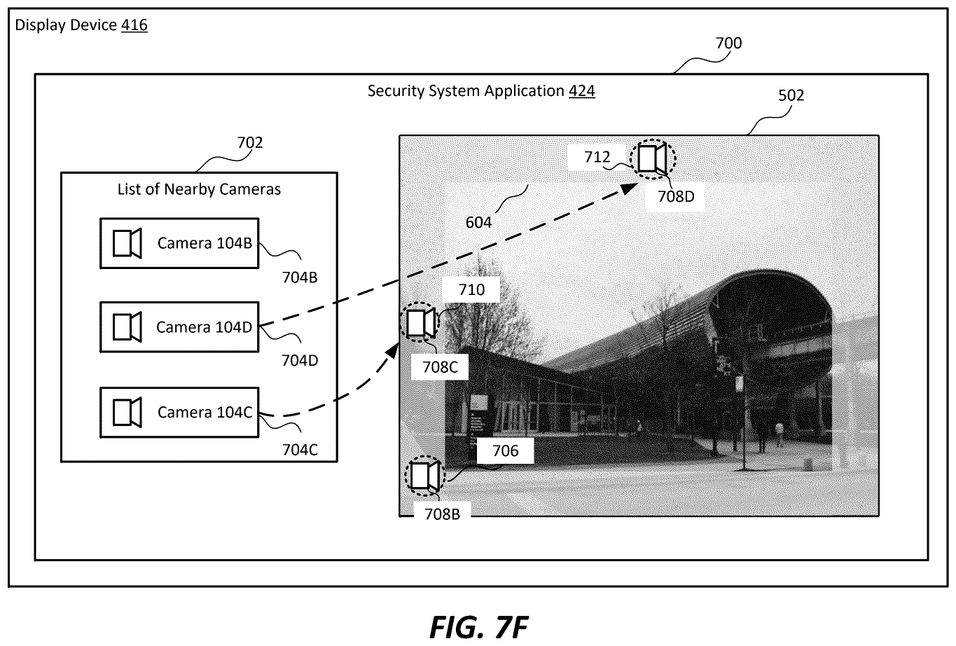

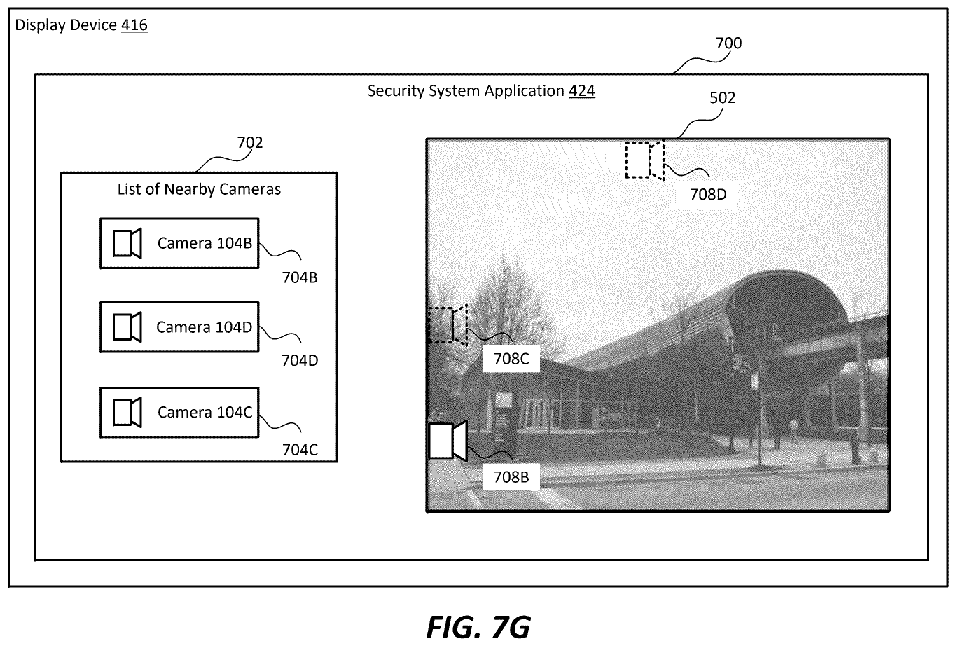

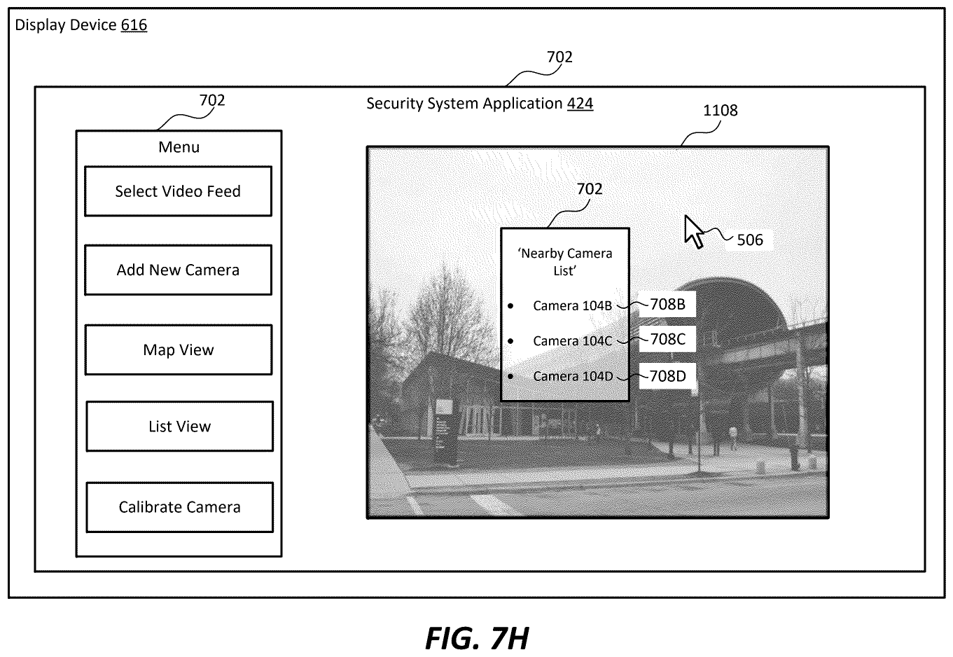

FIGS. 7A-7H illustrate an example graphical user interface that is presented to a user for configuring security cameras with visual tracking functionality, according to the present teachings. For example, FIGS. 7A-7H illustrate an example GUI 700 that is presented by the security system application 424 on the display device 416. As will be described in more detail herein, with the disclosed techniques, a user can interact with the GUI 700 of the security system application 424 to configure security cameras 104 with visual tracking functionality.

With reference to FIG. 7A, the GUI 700 includes the video tile 502 that can be used to display video data 318 generated by one or more security cameras 104. In the illustrated example of FIG. 7A, video data 318 generated by the security camera 104 is displayed within the video tile 502. In this example, the viewpoint of the security camera 104 (e.g., the physical angle and location from which the security camera 104 generates the video data displayed within the video tile 502) has not yet been configured and/or calibrated with respect to the locations of nearby security cameras 104 included in the security system 100. In the illustrated example of FIG. 7A, a transparent border 604 is displayed around the perimeter of the video tile 502 to indicate that security camera 104A has not yet been configured with visual tracking functionality.

As further shown in FIG. 7A, the “List View” option included in the menu 504 is selected using the cursor 506. Responsive to detecting a selection of the “List View” option, as shown in FIG. 7B, the GUI 700 presents a list view portion 702 alongside the video tile 502 in which video data 318 generated by the security camera 104A is displayed.

The list view portion 702 displays a list of the security cameras 104B-104D that are located nearby the security camera 104A (e.g., the security camera 104 generating the video feed displayed within video tile 502). In particular, the list view portion 702 displays a list comprising respective visual representations 704B-704D of the security cameras 104B-104D located nearby the security camera 104A. In the illustrated example of FIG. 7B, the visual representations 704B-704D of security cameras 104B-104D are presented in an order from closest to the viewpoint and/or location of security camera 104A to furthest from the viewpoint and/or location of security camera 104A. In some examples, the distance from the security camera 104A to a nearby security cameras 104 can be determined based on physical (e.g., real world) distance, for instance using known real-world positions (e.g., GPS coordinates), using a scaled map, or the like. In other examples, the distance from the security camera 104A to a nearby security cameras 104 is a pixel-based distance.

For example, assuming the security system application 424 determines, based on the camera configuration data 320, that security camera 104B is closest to the viewpoint and/or location of security camera 104A, the security system application 424 causes the visual representation 704B of security camera 104B to appear first in the list view portion 702. Likewise, assuming the security system application 424 determines, based on the camera configuration data 320, that security camera 104D is next closest to the viewpoint and/or location of security camera 104A, the security system application 424 causes the visual representation 704D of security camera 104D to appear second in the list view portion 702. Moreover, assuming the security system application 424 determines, based on the camera configuration data 320, that security camera 104C is third closest to the viewpoint and/or location of security camera 104A, the security system application 424 causes the visual representation 704C of security camera 104C to appear third in the list view portion 702. However, persons skilled in the art should understand that FIG. 7B is provided as a non-limiting example, and that in other examples, the security system application 424 can rank and/or order the visual representations 704B-704D according to one or more other criteria (e.g., walking distance, three-dimensional distance, as-the-crow-flies distance, etc.).

Furthermore, although visual representations 704A-704D of only three security cameras 104B-104D are displayed within the list view portion 702, in other examples, more or fewer visual representations 702 of nearby security cameras 104 can be displayed within the list view portion 702. For example, the user can define a predetermined number (e.g., 2, 3, 5, 10) of nearby security cameras 104 to be included in list view portion 702 in the form of visual representations 704. In some examples, the list view portion 702 includes a number of visual representations 704 of security cameras 104 that corresponds to the number of security cameras 104 located within a defined area surrounding the security camera 104A that is generating the video feed displayed within the video tile 502. In such examples, the user can set the value for the radius (e.g., 50 feet, 100 feet, 200 feet, etc.) of the are surrounding the security camera 104 generating the video feed displayed within the video tile 502. In that regard, to reduce the number of visual representations 704 of security cameras 104 included in the list view portion 702, the user can reduce the value for the radius of the area surrounding the security camera 104 that is generating the video feed displayed within video tile 502. Moreover, to increase the number the number of visual representations 704 of security cameras 104 included in the list view portion 702, the user can increase the value for the radius of the area surrounding the security camera 104 that is generating the video feed displayed within video tile 502. Other approaches for filtering and/or determining which of the other security cameras 104 should be displayed within the list view portion 702 can be implemented, including ranking based on popularity (which cameras are accessed most frequently), based on relevance (e.g., which cameras typically see the most objects), topological distance (e.g., how many rooms/spaces separate the cameras), and the like.

As further shown in the illustrated example of FIG. 7B, the visual representations 704B-704D of the security cameras 104B-104D are implemented using camera icons and corresponding text that identifies the security cameras 104B-104D. However, in other examples, the visual representations 704B-704D can be implemented using only text and/or one or more other types of symbols.

With reference to FIG. 7C, a user can begin configuring visual tracking functionality for the security camera 104A by defining a relationship between the viewpoint of security camera 104A (e.g., as shown in the video data displayed within the video tile 502) and one of the other security cameras 104 included in the security system 100. As described herein, in some cases, the relationship is a spatial relationship, in which both the distance (real-world or relative distance) and the angle between the viewpoint of security camera 104A and the other security camera 104 is known. In some other cases, the relationship is a directional relationship, in which only the angle (i.e., the direction from one to the other) between security camera 104A and the other security camera 104 is known. In the illustrated example FIG. 7C, the user selects (e.g., using cursor 506) the visual representation 704B of the security camera 104B to define a directional and/or spatial relationship between the viewpoint of the security camera 104A and the location and/or viewpoint of the security camera 104B.

Similar to the process described above with respect to FIGS. 6A-6U, after selecting the visual representation 704B of security camera 104B, the user can then select a position, or space, within the video tile 502 that is indicative of the relationship between the security camera 104B and the viewpoint of the security camera 104A. That is, because the video data displayed within the video tile 502 is captured from the viewpoint of the security camera 104A, the user can map the relationship between the security camera 104B and the viewpoint of the security camera 104A by selecting a space within the video tile 502 that corresponds (e.g., is adjacent to, points in the direction of, etc.) direction of the security camera 104B relative to the viewpoint of the security camera 104A. In the illustrated example of FIG. 7D, the user selects space 706 as the space within the video tile 502 that corresponds to the direction of the security camera 104B relative to the viewpoint of security camera 104A.

Although FIGS. 7C and 7D were described with respect to a user making a first selection of the visual representation 704B of security camera 104B and a second selection of space 706, in some examples, the two selections can be combined into a single user interaction (e.g., drag-and-drop with cursor 506) or divided into additional selections.

Responsive to detecting the user interaction(s) with the visual representation 704B of security camera 104B and the space 706 within the video tile 502 that corresponds to the direction of the security camera 104B relative to the viewpoint of security camera 104A, as shown in FIG. 7E, the security system application 424 causes the display of another visual representation 708B of the security camera 104B at space 706. The visual representation 708B is similar to the visual representation 612B described herein, and thus, any description of visual representation 612B is equally applicable to the visual representation 708B. In that regard, the visual representation 708B of security camera 104B can be selected by the user (e.g., using cursor 506) to navigate to a video feed generated by security camera 104B when visually tracking a subject appearing in the video tile 502.

Further in response to detecting the user interaction(s) with the visual representation 704B of security camera 104B and the space 706 within the video tile 502 that corresponds to the direction of the security camera 104B relative to the viewpoint of security camera 104A, as shown in FIG. 7F, the security system application 424 can update the camera configuration data 320 to reflect the calibrated viewpoint of the security camera 104A in the manner described above with respect to FIGS. 6A-6U. For example, the security system application 424 can determine and/or update one or more orientation values (e.g., azimuth, map azimuth, etc.) associated with the security camera 104A in response to detecting the user interaction(s) with the visual representation 704B of security camera 104B and the space 706 within the video tile 502. Moreover, the security system application 424 can store these orientation values as camera configuration data 320 and automatically create, based in part on these orientation values, visual representations 708C and 708D for security cameras 104C and 104D at the appropriate spaces within the transparent border 604 for security camera 104A in the manner described above with respect to FIGS. 6A-6U.

For example, in response to updating the camera configuration data 320 based in part on the user interaction(s) with the visual representation 704B of security camera 104B and the space 706 within the video tile 502, the security system application 424 can automatically cause display of another visual representation 708C of security camera 104C at a space 710 within the video tile 502 that corresponds to the direction of the security camera 104C relative to the viewpoint of security camera 104A. The location of space 710 within the video tile 502 can be automatically determined by the security system 424 using one or more of the techniques described herein with respect to FIGS. 6A-6U. Moreover, as the visual representation 708C is similar to the visual representation 612C described herein, any description of visual representation 612C is equally applicable to the visual representation 708C. In that regard, the visual representation 708C of security camera 104C can be selected by the user (e.g., using cursor 506) to navigate to a video feed generated by security camera 104C when visually tracking a subject appearing in the video tile 502.

As another example, in response to updating the camera configuration data 320 based in part on the user interaction(s) with the visual representation 704B of security camera 104B and the space 706 within the video tile 502, the security system application 424 can automatically cause display of another visual representation 708D of security camera 104D at a space 712 within the video tile 502 that corresponds to the direction of the security camera 104D relative to the viewpoint of security camera 104A. The location of space 712 within the video tile 502 can be automatically determined by the security system 424 using one or more of the techniques described herein with respect to FIGS. 6A-6U. Moreover, as the visual representation 708D is similar to the visual representation 612D described herein, any description of visual representation 612D is equally applicable to the visual representation 708D. In that regard, the visual representation 708D of security camera 104D can be selected by the user (e.g., using cursor 506) to navigate to a video feed generated by security camera 104D when visually tracking a subject appearing in the video tile 502.

FIG. 7G illustrates an example in which visual tracking functionality has been configured for the security camera 104A. As shown in FIG. 7G and described above, within the video tile 502 that is displaying video content generated by security camera 104A, the visual representation 708B of security camera 104B, which can be selected by a user to navigate to a video feed generated by security camera 104B, is inserted at a space within the video tile 502 that corresponds to the direction of security camera 104B relative to the viewpoint of security camera 104A. Moreover, within the video tile 502 that is displaying video content generated by security camera 104A, the visual representation 708C of security camera 104C, which can be selected by a user to navigate to a video feed generated by security camera 104C, is inserted at a space within the video tile 502 that corresponds to the direction of security camera 104C relative to the viewpoint of security camera 104A. Similarly, within the video tile 502 that is displaying video content generated by security camera 104A, the visual representation 708D of security camera 104D, which can be selected by a user to navigate to a video feed generated by security camera 104D, is inserted at a space within the video tile 502 that corresponds to the direction of security camera 104D relative to the viewpoint of security camera 104A.

In the illustrated example of FIG. 7G, the security system application 424 applies visual effects to the visual representations 708B-708D of security cameras 104B-104D to indicate relative distances between the viewpoint of security camera 104A and the locations of security cameras 104B-104D. In this example, visual representation 708C is made transparent and outlined in dashed lines to indicate that security camera 104C is furthest from security camera 104A. Moreover, in this example, visual representation 708D is outlined in dashed lines but has a solid fill to indicate that security camera 104D is further from security camera 104A than security camera 104B, but closer to security camera 104A than security camera 104C. In other examples, one or more of the other visual effects described herein can be applied to the visual representations 708B-708D of security cameras 104B-104D.

Although the list view portion 702 is described and shown in FIGS. 7B-7G as being displayed within the GUI 700 alongside the video tile 502, in some examples, the list view portion 702 can be displayed within and/or overlayed on top of the video tile 502. FIG. 7H illustrates an example in which the list view portion 702 is overlayed on top of the video tile 502. Like the list view portion 702 described herein with respect to FIGS. 7B-7G, the list view portion 702 shown in FIG. 7H includes visual representations 708B-708D of security cameras 104B-104D that can be interacted with by a user (e.g., using cursor 506) to configure security camera 104A with visual tracking functionality.

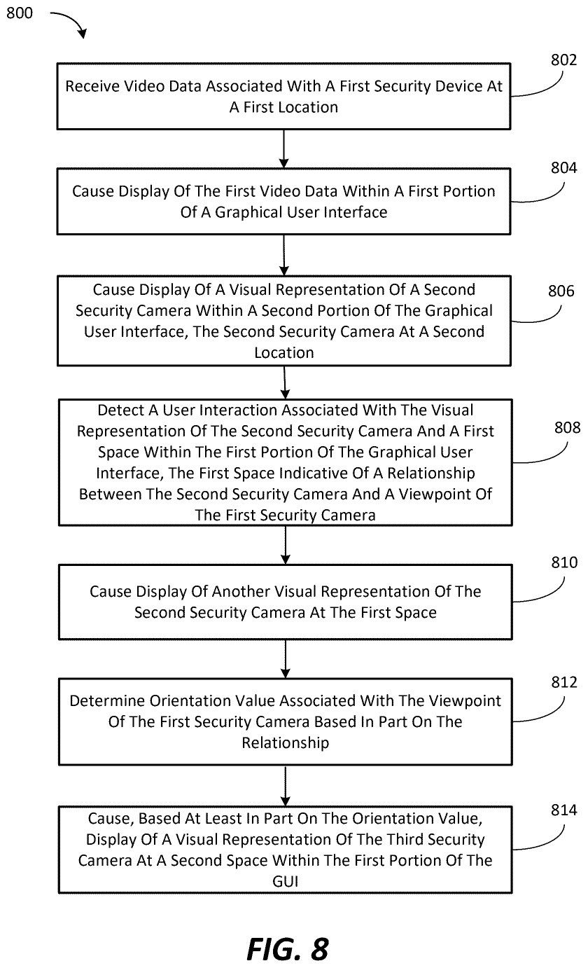

FIG. 8 is a flow diagram of method steps for configuring security cameras with visual tracking functionality, according to the present teachings. Although the method steps are described with reference to the systems and processes of FIGS. 1-7H, persons skilled in the art will understand that any system adapted to implement the method steps, in any order, falls within the scope of the present invention.

As shown, a method 800 begins at step 802, where video data associated with a first security camera at a first location is received. For example, the computing system 102 receives video data 318 generated by a security camera 104A installed at a first location. In some examples, the security system portal 314 implemented on the security system server 106 and/or the security system application 424 implemented on the security system computing device 108 receives the video data 318.

At step 804, the video data is caused to display within a first portion of a GUI. For example, the computing system 102 causes display of the video data 318 generated by the first security camera 104A within a video tile 502 of a GUI presented by security system application 424. In some examples, the security system portal 314 implemented on the security system server 106 causes display of the video data 318 within the video tile 502 of a GUI presented by the security system application 424 on the display device 416.

At step 806, a visual representation of a second security camera is caused to display within a second portion of the GUI, the second security camera installed at a second location. For example, the computing system 102 causes display of a visual representation 606B or 704B of a security camera 104B within a map view portion 602 or a list view portion 702 of a GUI presented by security system application 424. In some examples, the security system portal 314 implemented on the security system server 106 causes display of a visual representation 606B or 704B of the security camera 104B within a map view portion 602 or a list view portion 702 of a GUI presented by the security system application 424 on the display device 416.

At step 808, a user interaction associated with the visual representation of the second security camera and a first space within the first portion of the GUI is detected, the first space indicative of a relationship between the second security camera and a viewpoint of the first security camera. For example, the computing system 102 detects a user interaction associated with the visual representation 606B of security camera 104B and a first space within the video tile 502 of a GUI presented by the security system application 424, the first space indicative of a relationship between the security camera 104B and the viewpoint of the security camera 104A. In some examples, the security system portal 314 implemented on the security system server 106 detects a user interaction associated with the visual representation 606B of security camera 104B and the first space within the video tile 502 of a GUI presented by the security system application 424 on the display device 416. As described herein, in some examples, the relationship between the second security camera and the viewpoint of the first security camera is a spatial relationship.

At step 810, another visual representation of the second security camera is caused to display at the first space within the first portion of the GUI. For example, the computing system 102 causes, within the video tile 502, display of another visual representation 612B and/or 708B of the security camera 104B at the first space. In some examples, the security system portal 314 implemented on the security system server 106 causes, within the video tile 502 of a GUI presented by the security system application 424 on the display device 416, display of another visual representation 612B and/or 708B of the security camera 104B at the first space.

At step 812, an orientation value associated with the viewpoint of the first security camera. For example, the computing system 102 determines an orientation value (e.g., azimuth and/or some other orientation value described herein) associated with the viewpoint of the security camera 104A based in part the relationship between the second security camera 104B and the viewpoint of the security camera 104B indicated by the first space. In some examples, the security system portal 314 implemented on the security system server 106 determines the orientation value associated with the viewpoint of the security camera 104A based on the first space.

At step 814, display of a visual representation of a third security camera is caused to display at a second space within the first portion of the GUI based at least in part on the orientation value. For example, the computing system 102 causes, based in part on the orientation value associated with the viewpoint of the first security camera 104A, display of a visual representation 612C and/or 708C of the security camera 104C at a second space within the video tile 502. In some examples, the security system portal 314 implemented on the security system server 106 causes, based in part on the orientation value associated with the viewpoint of the first security camera 104A, display of a visual representation 612C and/or 708C of the security camera 104C at a second space within the video tile 502 of a GUI presented by the security system application 424 on the display device 416. As described herein, in some examples, orientation information and/or other camera configuration data 320 associated with the security camera 104C is further used in combination with the orientation value associated with the viewpoint of the first security camera 104A to determine the second space.

In addition to configuring security cameras 104 with visual tracking functionality as described herein, the disclosed techniques can also be used to automatically calibrate the viewpoints of security cameras 104 that were previously configured with visual tracking functionality. For example, in response to detecting a change associated with a viewpoint of a security camera 104, with the disclosed techniques, the security system application 424 can automatically calibrate the viewpoints of one or more security cameras 104 based on this detected change. In that regard, while a user is viewing a video feed generated by a security camera 104 that has been configured with visual tracking functionality, the security system application 424 can automatically update, based in part on a detected change to the viewpoint of the security camera 104 and/or another security camera 104, the respective positions of one or more visual representations of nearby security cameras 104 that are inserted in the video feed generated by the security camera 104.

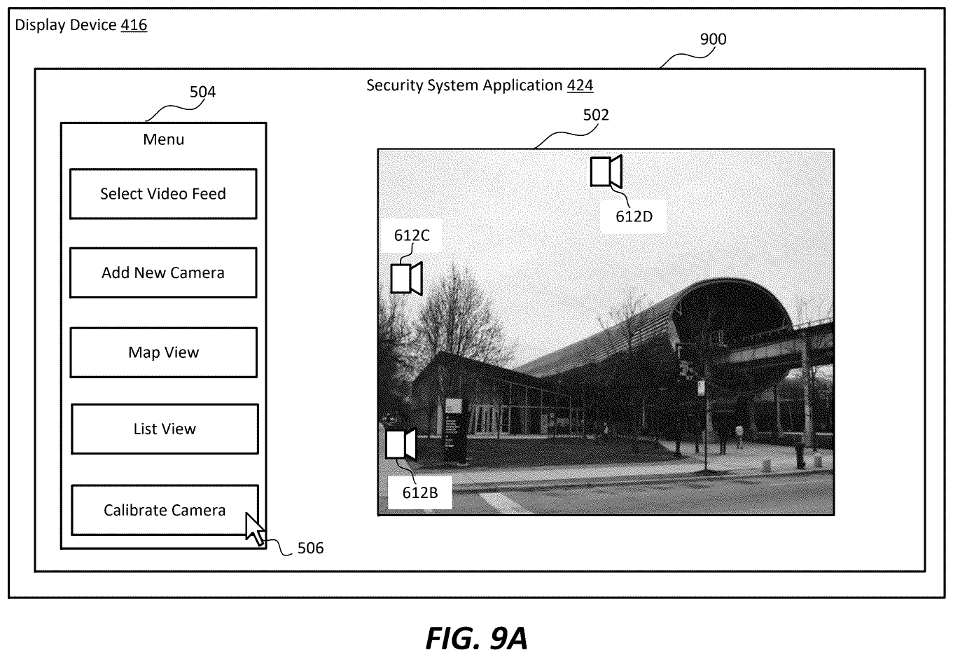

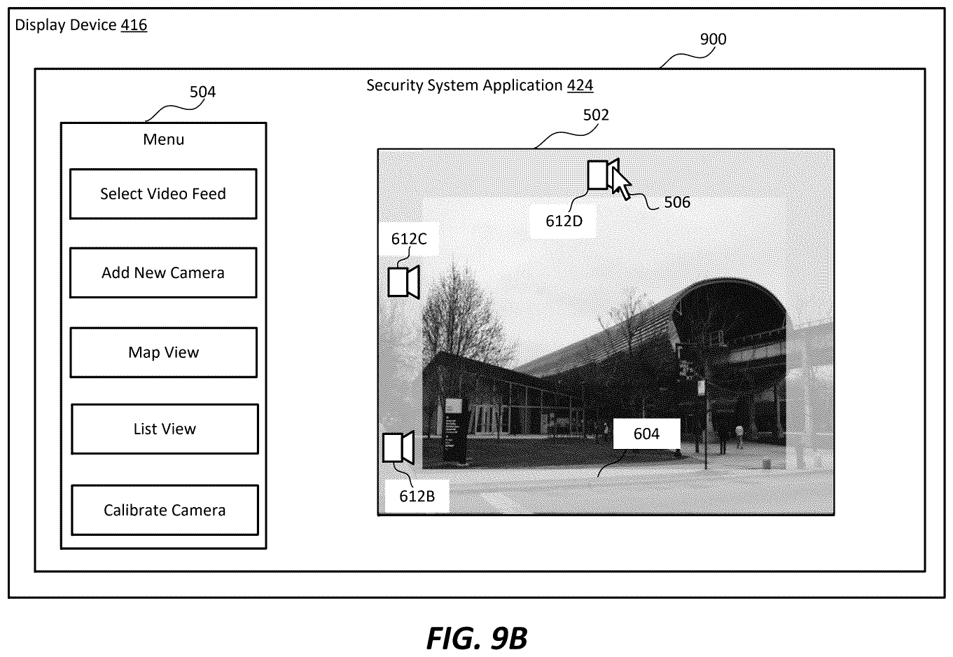

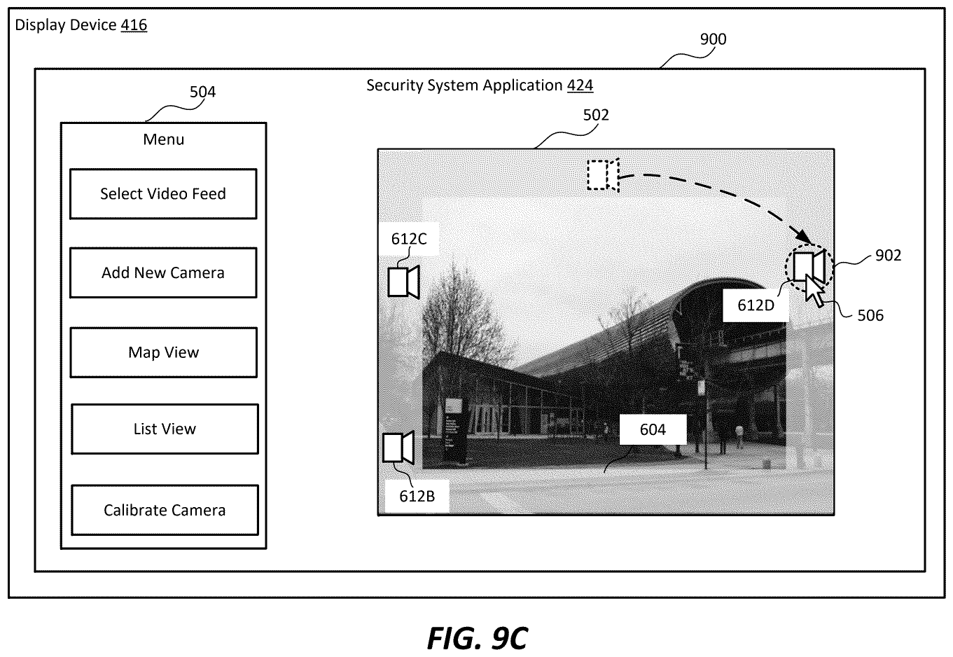

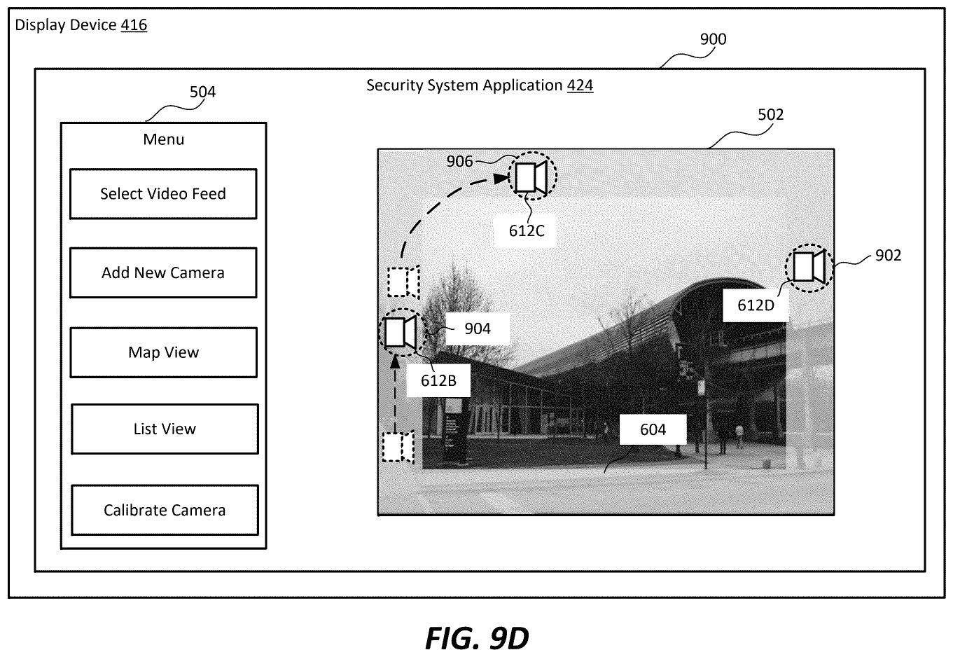

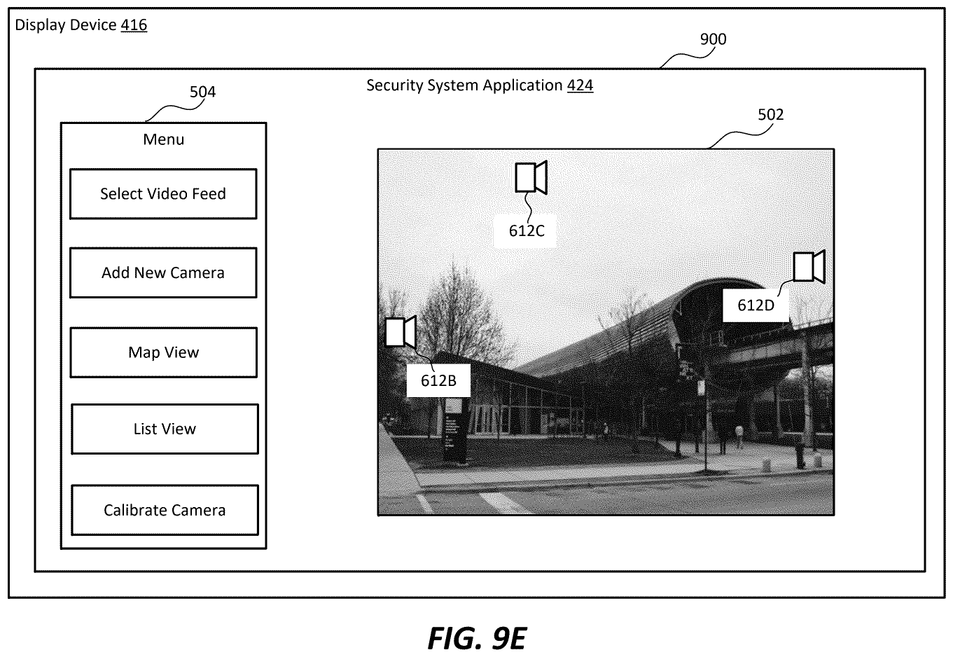

FIGS. 9A-9E illustrate an example graphical user interface that is presented to a user for calibrating viewpoints of security cameras, according to the present teachings. For example, FIGS. 9A-9E illustrate an example GUI 900 that is presented by the security system application 424 on the display device 416 of. As will be described in more detail herein, with the disclosed techniques, a user can interact with the GUI 900 of the security system application 424 to calibrate viewpoints of security cameras 104 with respect to other security cameras 104.

With reference to FIG. 9A, the GUI 900 includes the video tile 502 that can be used to display video data 318 generated by one or more security cameras 104. In the illustrated example of FIG. 9A, video data 318 generated by the security camera 104 is displayed within the video tile 502. Moreover, in this example, the security camera 104A has already been configured with visual tracking functionality. For example, the security system application 424 rendered display of visual representations 612B-612D of security cameras 104B-104D at respective spaces within the video tile 502, in accordance with the disclosed techniques.

In that regard, the space at which visual representation 612B of security camera 104B is displayed within the video tile 502 corresponds to a previously established relationship between the viewpoint of security camera 104A and the security camera 104B. As described herein, this previously established relationship between the viewpoint of security camera 104A and the security camera 104B can be implicitly or explicitly defined by information included in the camera configuration data 320. Similarly, the space at which visual representation 612C of security camera 104C is displayed within the video tile 502 corresponds to a previously established relationship between the viewpoint of security camera 104A and the security camera 104C. As described herein, this previously established relationship between the viewpoint of security camera 104A and the security camera 104C can be implicitly or explicitly defined by information included in the camera configuration data 320. Moreover, the space at which visual representation 612D of security camera 104D is displayed within the video tile 502 corresponds to a previously established relationship between the viewpoint of security camera 104A and the security camera 104D. As described herein, this previously established relationship between the viewpoint of security camera 104A and the security camera 104D can be implicitly or explicitly defined by information included in the camera configuration data 320.

As further shown in FIG. 9A, the “Calibrate Camera” option included in the menu 504 is selected using the cursor 506. A user may select the “Calibrate Camera” option to calibrate, or adjust, the viewpoint of security camera 104A relative to the locations of one or more other security cameras 104 (e.g., security cameras 104B-104D). As will be described in more detail herein, within the context of visual tracking, calibrating the viewpoint of camera 104A includes automatically updating the respective positions of one or more of the visual representations 612B-612D within video tile 502 based in part on a detected update to the orientation information (e.g., angle, azimuth, position, etc.) associated with the viewpoint of a first security camera and/or location information associated with a second security camera 104.

In some examples, responsive to detecting a selection of the “Calibrate Camera” option, the security system application 424 may enter a calibration mode. In the illustrated example of FIG. 9B, the calibration mode is indicated by the transparent border 604 displayed around the perimeter of video tile 502. In some examples, an explicit user selection is not required for security system 424 to enter a calibration mode. In such examples, one or more of the steps described herein with respect to FIGS. 9C-9E can be performed without first selecting the “Calibrate Camera” option included in menu 504.

As further shown in FIG. 9B, a user can begin calibrating the viewpoint of security camera 104A by updating a relationship between the viewpoint of security camera 104A and another security camera 104B-104D that is represented in the video tile 502 by visual representations 612B-612D. Hereinafter, updating the relationship between the viewpoint of security camera 104A and the other security cameras 104 can be referred to as calibrating the viewpoint of security camera 104A with respect to those one or more security cameras 104.

There may be various reasons as to why the user may need and/or desire to calibrate the viewpoint of security camera 104A with respect to another security camera 104. For example, without limitation, a user may need and/or desire to calibrate the viewpoint of security camera 104A with respect to another security camera 104 for instances in which the viewpoint of security camera 104A has drifted over time, for instances in which the location of another security camera 104 has changed over time, for instances in which security camera 104A is a PTZ camera and one or more of the pan, tilt, or zoom values for security camera 104A have been adjusted, for instances in which another security camera 104 is a PTZ camera and one or more of the pan, tilt, or zoom values for the another security camera 104 have been updated, and/or for any other reasons not explicitly mentioned herein but that may warrant calibration of the viewpoint of security camera 104A relative to one or more other security cameras 104. For instance, the precision of the relationships between the security cameras 104 may be improved through multiple calibrations of different ones of the security cameras 104, and thus repeating the calibration of the security cameras 104 may be desirable.

In the illustrated example of FIG. 9B, the user selects (e.g., using cursor 506) the visual representation 612D of the security camera 104D to update the relationship between the viewpoint of the security camera 104A and the security camera 104D (e.g., the location of security camera 104D). Similar to the processes described above with respect to FIGS. 6A-6U and FIGS. 7A-7H, after selecting the visual representation 612D of security camera 104D, the user can then select an updated position, or space, within the video tile 502 that corresponds to an updated relationship between the security camera 104D and the viewpoint of the security camera 104A. That is, where the current space at which visual representation 612D of security camera 104D is displayed within the video tile 502 may be outdated (e.g., uncalibrated), the user can select a new position, or space, within the video tile 502 that corresponds to the updated direction of the security camera 104D relative to the viewpoint of the security camera 104A and the security camera 104D.

In the illustrated example of FIG. 9C, the user selects space 902 as the space within the video tile 502 that corresponds to the updated relationship between the of the security camera 104D and the viewpoint of security camera 104A. As further shown in the illustrated example of FIG. 9C, responsive to detecting the user interaction(s) with the visual representation 612D of security camera 104D and the space 902 within the video tile 502 that corresponds to the updated relationship of the security camera 104D and the viewpoint of security camera 104A, the security system application 424 automatically causes the display of the visual representation 612D of the security camera 104D to move from its initial space within the video tile 502 to space 902. Further in response to detecting the user interaction(s) with the visual representation 612D of security camera 104D and the space 902, the security system application 424 can automatically updates the camera configuration data 320 with information that is indicative of the updated relationship between the viewpoint of security camera 104A and the security camera 104D (e.g., an updated orientation value associated with the viewpoint of security camera 104A, an updated location of security camera 104D, etc.).

Although FIGS. 9B and 9C were described with respect to a user making a first selection of the visual representation 612D of security camera 104D and a second selection of space 902, in some examples, the two selections can be combined into a single user interaction (e.g., drag-and-drop with cursor 506) or divided into additional selections.

Responsive to determining and updating the camera configuration data 320 with information that is indicative of the updated relationship between the viewpoint of security camera 104A and the security camera 104D (e.g., an updated orientation value associated with the viewpoint of security camera 104A, an updated location of security camera 104D, etc.), as shown in FIG. 9D, the security system application 424 can automatically calibrate the viewpoint of security camera 104A with respect to security camera 104B, security camera 104C, and/or one or more other security cameras 104 that are not represented in the video feed portion with visual representations 612.

For example, using similar techniques to those described herein with respect to FIGS. 6A-6U and 7A-7H, the security system application 424 can automatically determine that space 904 corresponds to an updated relationship between the security camera 104B and the viewpoint of security camera 104A based in part on (i) the information included in camera configuration data 320 that is indicative of the updated relationship between the viewpoint of security camera 104A and the security camera 104D (e.g., an updated orientation value associated with the viewpoint of security camera 104A, an updated location of security camera 104D, etc.) and/or (ii) location and/or direction information associated with the security camera 104B. In some examples, the security system application 424 determines that space 904 corresponds to an updated relationship between the security camera 104B and the viewpoint of security camera 104A based in part on the movement of the visual representation 612D of security camera 104D from an initial space in the video tile 502 to space 902. After determining that space 904 corresponds to the updated relationship between the security camera 104B and the viewpoint of security camera 104A, the security system application 424 automatically causes the display of the visual representation 612B of the security camera 104B to move from its initial space within the video tile 502 to space 904.

As another example, the security system application 424 can automatically determine that space 906 corresponds to an updated relationship between the location and/or viewpoint of the security camera 104C and the viewpoint of security camera 104A based in part on (ii) the information included in camera configuration data 320 that is indicative of the updated relationship between the viewpoint of security camera 104A and the security camera 104D (e.g., an updated orientation value associated with the viewpoint of security camera 104A, an updated location of security camera 104D, etc.) and/or (ii) location and/or direction information associated with the security camera 104C. In some examples, the security system application 424 determines that space 906 corresponds to an updated relationship between the security camera 104C and the viewpoint of security camera 104A based in part on the movement of the visual representation 612D of security camera 104D from an initial space in the video tile 502 to space 902. After determining that space 906 corresponds to the updated relationship between the security camera 104C and the viewpoint of security camera 104A, security system application 424 automatically causes the display of the visual representation 612C of the security camera 104C to move from its initial space within the video tile 502 to space 906.

FIG. 9E illustrates the result of calibrating the viewpoint of security camera 104A. As shown in FIG. 9E, each of the visual representations 612B-612D are displayed at respective spaces within the video tile 502 that correspond to the updated relationships between the viewpoint of security camera 104A and the I security cameras 104B-104D. Although no visual effects are applied to the visual representations 612B-612D in the illustrated example of FIG. 9E, in some examples, the security system application 424 can apply one or more of the visual effects described herein to one or more of the visual representations 612B-612D.

The example process for calibrating the viewpoint of security camera 104A that was described with respect to FIGS. 9A-9E included the step(s) of the user selecting a new space within the video feed portion to which the visual representation 612D of security camera 104D should be moved. However, in some examples, the security system application 424 can automatically calibrate the viewpoint of a security camera 104 without detecting a user selection of a visual representation 612 of a security camera 104 and/or a user selection of a new space within the video tile 502 to which that visual representation 612 of a security camera 104 should be moved. In such examples, the security system application 424 can automatically calibrate the viewpoint of a security camera 104 in response to detecting some other event associated with a change in the viewpoint of a security camera 104 and/or a change in the viewpoint of some other security camera 104.

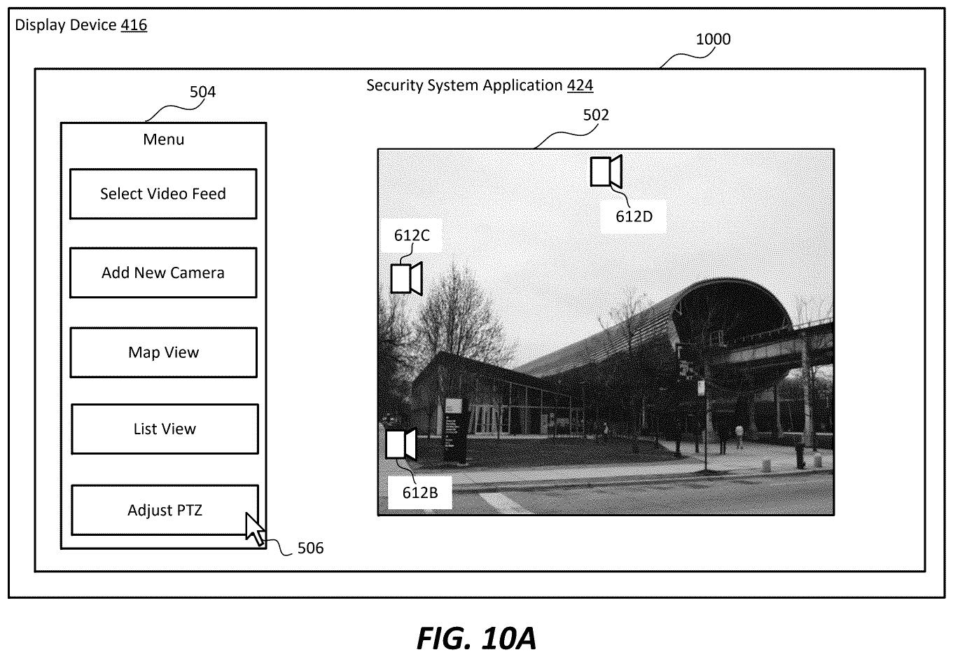

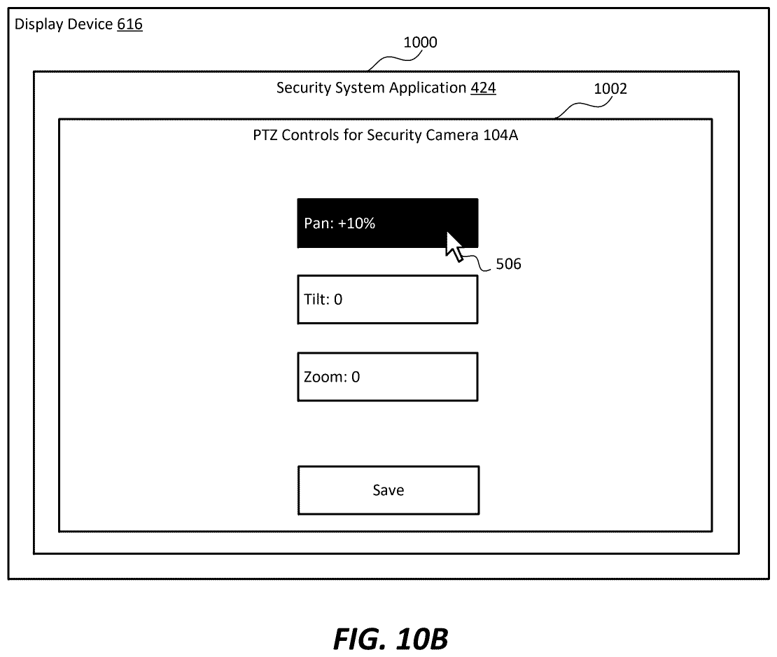

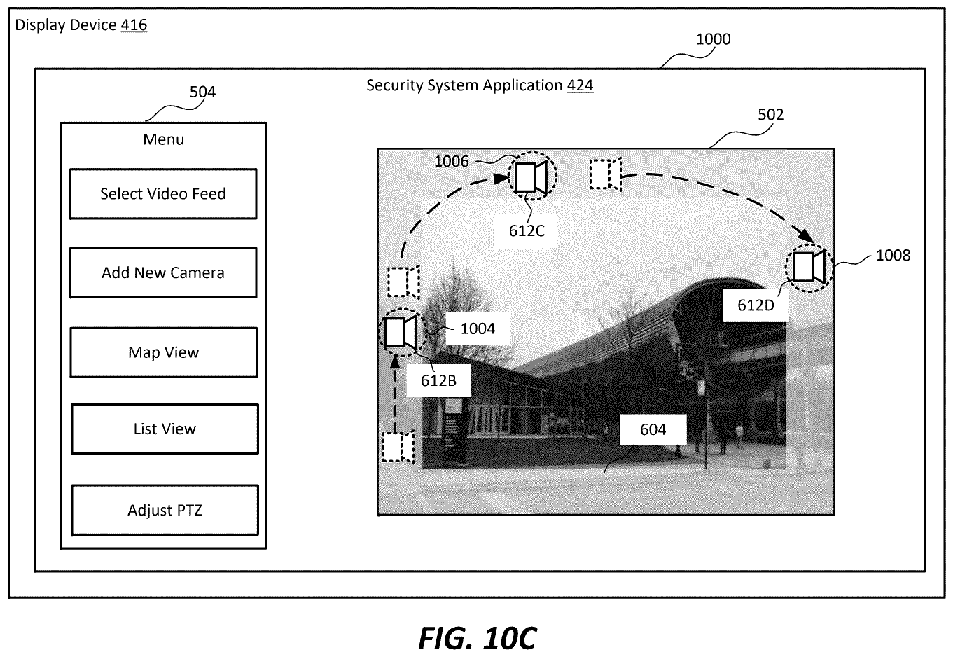

FIGS. 10A-10C illustrate an example graphical user interface that is presented to a user for calibrating viewpoints of security cameras, according to the present teachings. For example, FIGS. 10A-10C illustrate an example GUI 1000 that is presented by the security system application 424 on the display device 416. As will be described in more detail herein, with the disclosed techniques, a user can interact with the GUI 1000 of the security system application 424 to calibrate viewpoints of security cameras 104 with respect to other security cameras 104.

With reference to FIG. 10A, the GUI 1000 includes the video tile 502 that can be used to display video data generated by one or more security cameras 104. In the illustrated example of FIG. 10A, video data generated by the security camera 104 is displayed within the video tile 502. Moreover, in this example, the security camera 104A has already been configured with visual tracking functionality. For example, the security system application 424 has rendered display of visual representations 612B-612D of security cameras 104B-104D at respective spaces within the video tile 502, in accordance with the disclosed techniques.

In that regard, the space at which visual representation 612B of security camera 104B is displayed within the video tile 502 corresponds to a previously established relationship between the viewpoint of security camera 104A and the security camera 104B. As described herein, this previously established relationship between the viewpoint of security camera 104A and the security camera 104B can be implicitly or explicitly defined by information included in the camera configuration data 320. Similarly, the space at which visual representation 612C of security camera 104C is displayed within the video tile 502 corresponds to a previously established relationship between the viewpoint of security camera 104A and the security camera 104C. As described herein, this previously established relationship between the viewpoint of security camera 104A and the security camera 104c can be implicitly or explicitly defined by information included in the camera configuration data 320. Moreover, the space at which visual representation 612D of security camera 104D is displayed within the video tile 502 corresponds to a previously established relationship between the viewpoint of security camera 104A and the security camera 104D. As described herein, this previously established relationship between the viewpoint of security camera 104A and the security camera 104D can be implicitly or explicitly defined by information included in the camera configuration data 320.

As further shown in FIG. 10A, the menu 504 includes an “Adjust PTZ” option. In the illustrated examples of FIGS. 10A-10C, the security camera 104A is a PTZ camera. Thus, a user may select the “Adjust PTZ” option to adjust one or more of the pan value, the tilt value, or the zoom value of the security camera 104A. Responsive to detecting a selection of the “Adjust PTZ” option, as shown in FIG. 10B, the GUI 1000 presents a menu 1002 for adjusting one or more of the pan of security camera 104A, the tilt of the security camera 104A, and the zoom of security camera 104A. In the illustrated example of FIG. 10B, the user increases the pan of security camera 104A by 10%.

Responsive to receiving the input to increase the pan of security camera 104A by 10%, the security system application 424 causes (e.g., via PTZ hardware 216), the pan of security camera 104A to increase by 10%. Further in response to receiving the input to increase the pan of security camera 104A by 10%, the security system application 424 automatically determines updated relationships between the viewpoint of the security camara 104A and the security cameras 104B-104D using one or more of the techniques described herein.

With reference to FIG. 10C, the security system application 424 then automatically causes movement of the visual representations 612B-612D of security cameras 104B-104D from their current positions in the video tile 502 to new spaces within the video tile 502 based on the updated relationships between the viewpoint of the security camara 104A and the security cameras 104B-104D. For example, based in part on the detected increase in the pan value of security camera 104A, the security system application 424 determines that space 1004 within the video tile 502 corresponds to an updated relationship between the viewpoint of security camera 104A and the security camera 104B. Moreover, in this example, security system application 424 causes movement of the visual representation 612B of security camera 104B to the space 1004. Similarly, the security system application 424 determines, based in part on the detected increase in the pan value of security camera 104A, that (i) space 1006 within the video tile 502 corresponds to the updated relationship between the viewpoint of security camera 104A and the security camera 104C and (ii) space 1008 within the video tile 502 corresponds to the updated relationship between the viewpoint of security camera 104A and the security camera 104D. Accordingly, the security system application 424 causes movement of the visual representation 612C of security camera 104C to the space 1006 and movement of the visual representation 612D of security camera 104D to the space 1008.

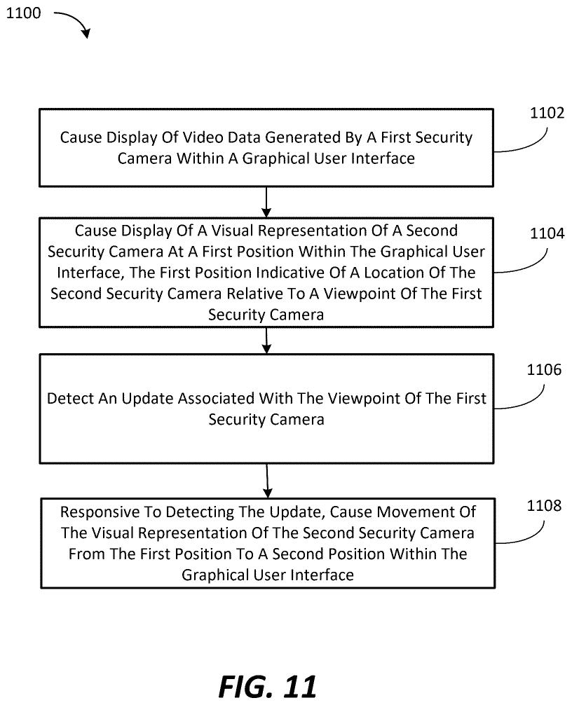

FIG. 11 is a flow diagram of method steps for calibrating viewpoints of security cameras, according to the present teachings. Although the method steps are described with reference to the systems and processes of FIGS. 1-10C, persons skilled in the art will understand that any system adapted to implement the method steps, in any order, falls within the scope of the present invention.

As shown, a method 1100 begins at step 1102, where video data generated by a first security camera video data is caused to within a GUI. For example, the computing system 102 causes display of the video data 318 generated by the first security camera 104A within a video tile 502 of a GUI 900 or a GUI 1000 presented by security system application 424. In some examples, the security system portal 314 implemented on the security system server 106 causes display of the video data 318 within the video tile 502 of the GUI 900 or the GUI 1000 presented by the security system application 424 on the display device 416.

At step 1104, a visual representation of a second security camera is caused to display a first position within the GUI, the first position indicative of a location of the second security camera relative to a viewpoint of the first security camera. For example, the computing system 102 causes display of a visual representation 612B of a security camera 104B at a first position within the video tile 502 of a GUI 900 or a GUI 1000 presented by security system application 424. In some examples, the security system portal 314 implemented on the security system server 106 causes display of a visual representation 612B of a security camera 104B at a first position within the video tile 502 of a GUI 900 or a GUI 1000 presented by the security system application 424 on the display device 416.

At step 1106, an updated associated with the viewpoint of the first security camera is detected. For example, the computing system 102 detects an update associated with the viewpoint of the security camera 104A. In some examples, the security system portal 314 implemented on the security system server 106 detects the updated associated with the viewpoint of the security camera 104A. In some examples, as described herein, the update associated with the viewpoint of the security camera 104A corresponds to a user interaction between a visual representation of another security camera 104 and a space within the video tile 502 that is displaying the video feed generated by the security camera 104. In some examples, the update associated with the viewpoint of the security camera 104A corresponds to a change in a PTZ value and/or a change in a location of the security camera 104A.

At step 1108, the visual representation of the second security camera is caused to move from the first position to a second position within the GUI responsive to detection of the update. For example, the computing system 102 causes movement of the visual representation 612B of the security camera 104B from the first position to a second position within the video tile 502 of GUI 900 or GUI 1000 in response to detecting the update associated with the viewpoint of the security camera 104A.

In some examples, method 1100 comprises the additional steps of (i) causing a visual representation of a third security camera to display at a third position within the GUI and (ii) causing movement of the visual representation of the third security camera from the third position to a fourth position within the GUI responsive to detection of the update. For example, the method 1100 can additionally comprise: (i) the computing system 102 causing display of a visual representation 612C of a security camera 104C at a third position within the video tile 502 of a GUI 900 or a GUI 1000 presented by security system application 424 and (ii) the computing system 102 causing movement of the visual representation 612C of the security camera 104C from the third position to a fourth position within the video tile 502 of GUI 900 or GUI 1000 in response to detecting the update associated with the viewpoint of the security camera 104A.

Although the techniques described herein include calibrating the viewpoint of a security camera 104 with respect to one or more other security cameras 104 included in the security system, in some examples, a user may desire to calibrate the viewpoint of a security camera 104A based on non-camera devices, landmarks, and/or other structures. For example, if the viewpoint of a security camera 104 is directed towards and captures a landmark, such as a statue, and that landmark is indicated as with a visual representation in the map view portion 602 of the GUI, using one or more of the techniques described herein with respect to the visual representations 606 of the security cameras 104, a user can interact with the visual representation of the of the landmark displayed in the map view portion 602 and a corresponding space within the video tile 502 (e.g., drag-and-drop) to calibrate the viewpoint of the security camera 104 with respect to the landmark. By way of another example, a user of the security system application 424 can specify a “global” reference device or landmark (e.g., the main entrance to a building), and thereinafter, the global reference can be suggested to a user when calibrating the viewpoint of a security camera 104.

Furthermore, in some examples, the security system application 424 can display visual representations of non-camera devices (e.g., access control readers, a door, etc.) as nearby devices in the map view portion 602 and/or the list view portion 702. In such examples, using one or more of the techniques described herein with respect to security cameras 104 (e.g., using drag-and-drop), a user can interact with (i) a visual representation of a non-camera device displayed in the map view portion 602 and/or the list view portion 702 and (ii) a corresponding space in the video tile 502 to cause display of another visual representation of the non-camera device at the corresponding space in the video tile 502. Then, in such examples, if a user interacts with the visual presentation of the non-camera device displayed in the video tile 502, a list of recent events witnessed by the non-camera device (e.g., if the non-camera device is an access control reader, a list of badge reads that occurred in the past five minutes; if the non-camera device is a door, a list of opens and closes in the past ten minutes; etc.) can be presented to the user within the GUI of security system application 424. As another example, if a user interacts with the visual presentation of the non-camera device displayed in the video tile 502, a video feed generated by a security camera 104 located nearby the non-camera device can be presented in the video tile 502 and/or a different video tile. For example, if the non-camera device is a door, the video feed of a security camera 104 associated with the door can be displayed within the video tile 502.

Furthermore, in some examples, the security system application 424 can selectively display a visual representation of a non-camera device within the video tile 502 only when the non-camera device is producing an alert (e.g., non-camera device is a door and/or badge reader and the door is forced open, non-camera device detects and/or is associated with an intrusion, non-camera device is a smoke alarm and a fire is occurring, etc.) and/or is otherwise pertinent to the user of security system application 424. In some examples, the alert associated with the non-camera device can be displayed at a location and/or space in the video tile 502 that corresponds to the location of the non-camera device relative to the viewpoint of the security camera 104 generating the video feed (e.g., when the non-camera device is likely to be collocated with the alert) and/or or at a location and/or space within the video tile 502 associated with the event that generated the alert (e.g., when the non-camera device is likely not collocated with the alert). In some examples, alerts that are not “nearby” the security camera 104 generating the video feed displayed within the video tile 502 may still be indicated within the video tile 502 based on distance and/or area settings configured by the user for displaying visual representations of nearby security cameras 104.

1. In some embodiments, a security system comprising a computing system adapted to cause display of video data generated by a first security camera within a graphical user interface; the computing system adapted to cause display of a visual representation of a second security camera at a first position within the graphical user interface, the first position indicative of a location of the second security camera relative to a viewpoint of the first security camera; the computing system adapted to detect an update associated with the viewpoint of the first security camera; and responsive to detecting the update, the computing system adapted to cause movement of the visual representation of the second security camera from the first position to a second position within the graphical user interface.

2. The security system of clause 1, wherein the computing system is adapted to cause display of a visual representation of a third security camera at a third position within the graphical user interface, the third position indicative of a location of the third security camera relative to a viewpoint of the first security camera; and responsive to detecting the update, the computing system adapted to cause movement of the visual representation of the third security camera from the third position to a fourth position within the graphical user interface.

3. The security system of clauses 1 or 2, wherein the first position and the second position are located within a border displayed within the graphical user interface, the border surrounding the video data displayed within the graphical user interface.

4. The security system of any of clauses 1-3, wherein a size of the visual representation of the second security camera corresponds to a distance between the first security camera and the second security camera.

5. The security system of any of clauses 1-4, wherein the update includes a change in an orientation value of the first security camera.

6. The security system of any of clauses 1-5, wherein the update is detected in response to a user interaction with the second position.

7. The security system of any of clauses 1-6, wherein the computing system is adapted to cause movement of the visual representation of the second security camera from the first position to the second position in response to detecting a user interaction with the second position.

8. The security system of any of clauses 1-8, wherein the first security camera comprises a video camera.

9. The security system of any of clauses 1-9, wherein the computing system includes a plurality of processors in electronic communication with each other via a network; and a plurality of displays coupled to the plurality of processors.

10. In some embodiments, a security system comprising a computing system adapted to cause display of video data generated by a first security camera within a first portion of a graphical user interface; the computing system adapted to cause display of a visual representation of a second security camera within a second portion of the graphical user interface; the computing system adapted to cause display of a visual representation of a third security camera within the second portion; the computing system adapted to detect a user input associated with the visual representation of the second security camera and a first space within the first portion, the first space indicative of a location of the second security camera relative to a viewpoint of the first security camera; the computing system adapted to determine an orientation value associated with the viewpoint of the first security camera based in part on the user input; and the computing system adapted to cause, based at least in part on the orientation value and a location of the third security camera, display of another visual representation of the third security camera at a second space within the first portion, the second space is indicative of the location of the third security camera relative to the viewpoint of the first security camera.

11. The security system of clause 10, wherein the computing system is adapted to cause display of another visual representation of the second security camera at the first space.

12. The security system of clauses 10 or 11, wherein a first distance between a location of the first security camera and the location of the second security camera is less than a second distance between the location of the first security camera and the location of the third security camera; and the another visual representation of the second security camera displayed within the first portion is larger than the another visual representation of the third security camera.

13. The security system of any of clauses 10-12, wherein the another visual representation of the second security camera comprises a first icon depicting the second security camera; and the another visual representation of the third security camera comprises a second icon depicting the third security camera.

14. The security system of any of clauses 10-13, wherein the computing system is adapted to apply a first visual effect to the another visual representation of the second security camera based on a first distance between a location of the first security camera and the location of the second security camera; and the computing system is adapted to apply a second visual effect to the another visual representation of the third security camera based on a second distance between the location of the first security camera and the location of the third security camera.

15. The security system of any of clauses 10-14, wherein the computing system is adapted to detect a second user input associated with another visual representation of the second security camera displayed at the first space within the first portion; responsive to detecting the second user interaction, the computing system is adapted to cause display of second video data generated by the second security camera within the first portion; and the computing system is adapted to move the another visual representation of the third security camera from the second space to a third space within the first portion, the third space indicative of the location of the third security camera relative to a viewpoint of the second security camera.

16. The security system of any of clauses 10-15, wherein the computing system is adapted to cause display of a visual representation of the first security camera at a fourth space within the first portion, the fourth space indicative of the location of the first security camera relative to the viewpoint of the second security camera.

17. The security system of any of clauses 10-16, wherein the second portion comprises a map of an area monitored by the security system; and the visual representation of the second security camera is displayed at a position on the map that corresponds to the second location.

18. The security system of any of clauses 10-17, wherein the second portion comprises a list of security cameras that are located nearby the first security camera.

19. In some embodiments, a security system managing a plurality of security cameras adapted to generate video data. The security system comprising a computing system adapted to receive video data associated with a first security camera at a first location; the computing system adapted to cause display of the video data within a first portion of a graphical user interface; the computing system adapted to cause display of a visual representation of a second security camera within a second portion of the graphical user interface, the second security camera at a second location; the computing system adapted to detect a user interaction associated with the visual representation of the second security camera and a first space within the first portion of the graphical user interface, the first space indicative of a relationship between the second security camera and a viewpoint of the first security camera; the computing system adapted to cause display of another visual representation of the second security camera at the first space; the computing system adapted to determine an orientation value associated with the viewpoint of the first security camera based in part on the relationship; and the computing system is adapted to cause, based at least in part on the orientation value, display of a visual representation of the third security camera at a second space within the first portion of the graphical user interface.

20. The security system of clause 19, wherein the first security camera is a pan-tilt-zoom camera; the computing system adapted to detect a change in a pan value of the first security camera; the computing system adapted to determine an updated orientation value associated with the viewpoint of the first security camera based in part on the pan value; and the computing system adapted to cause, based in part on the updated orientation value, movement of the another visual representation of the second security camera from the first space to a third space within the first portion of the first graphical user interface.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

1. A security system, comprising:
a computing system adapted to cause display of video data generated by a first security camera within a graphical user interface;
the computing system adapted to cause display of a visual representation of a second security camera at a first position within the graphical user interface, the first position indicative of a location of the second security camera relative to a viewpoint of the first security camera;
the computing system adapted to detect an update associated with the viewpoint of the first security camera; and
responsive to detecting the update, the computing system adapted to cause movement of the visual representation of the second security camera from the first position to a second position within the graphical user interface.

2. The security system of claim 1, wherein:
the computing system is adapted to cause display of a visual representation of a third security camera at a third position within the graphical user interface, the third position indicative of a location of the third security camera relative to a viewpoint of the first security camera; and
responsive to detecting the update, the computing system adapted to cause movement of the visual representation of the third security camera from the third position to a fourth position within the graphical user interface.

3. The security system of claim 1, wherein the first position and the second position are located within a border displayed within the graphical user interface, the border surrounding the video data displayed within the graphical user interface.

4. The security system of claim 1, wherein:
a size of the visual representation of the second security camera corresponds to a distance between the first security camera and the second security camera.

5. The security system of claim 1, wherein the update includes a change in an orientation value of the first security camera

6. The security system of claim 1, wherein the update is detected in response to a user interaction with the second position.

7. The security system of claim 1, wherein the computing system is adapted to cause movement of the visual representation of the second security camera from the first position to the second position in response to detecting a user interaction with the second position.

8. The security system of claim 1, wherein the first security camera comprises a video camera.

9. The security system of claim 1, wherein the computing system includes:
a plurality of processors in electronic communication with each other via a network; and
a plurality of displays coupled to the plurality of processors.

10. The security system of claim 1, further comprising:
the computing system adapted to cause display of the video data generated by the first security camera within a first portion of the graphical user interface;
the computing system adapted to cause display of a visual representation of a third security camera within a second portion of the graphical user interface;
the computing system adapted to cause display of a visual representation of a fourth security camera within the second portion;
the computing system adapted to detect a user input associated with the visual representation of the third security camera and a first space within the first portion, the first space indicative of a location of the third security camera relative to the viewpoint of the first security camera;
the computing system adapted to determine an orientation value associated with the viewpoint of the first security camera based in part on the user input; and
the computing system adapted to cause, based at least in part on the orientation value and a location of the fourth security camera, display of another visual representation of the fourth third security camera at a second space within the first portion, the second space is indicative of the location of the fourth security camera relative to the viewpoint of the first security camera.

11. The security system of claim 10, wherein the computing system is adapted to cause display of another visual representation of the third security camera at the first space.

12. The security system of claim 11, wherein:
a first distance between a location of the first security camera and the location of the third security camera is less than a second distance between the location of the first security camera and the location of the fourth security camera; and
the another visual representation of the third security camera displayed within the first portion is larger than the another visual representation of the fourth security camera.

13. The security system of claim 11, wherein:
the another visual representation of the third security camera comprises a first icon depicting the third security camera; and
the another visual representation of the fourth security camera comprises a second icon depicting the fourth third security camera.

14. The security system of claim 13, wherein:
the computing system is adapted to apply a first visual effect to the another visual representation of the third security camera based on a first distance between a location of the first security camera and the location of the third security camera; and
the computing system is adapted to apply a second visual effect to the another visual representation of the fourth security camera based on a second distance between the location of the first security camera and the location of the fourth security camera

15. The security system of claim 10, wherein:
the computing system is adapted to detect a second user input associated with another visual representation of the third security camera displayed at the first space within the first portion;
responsive to detecting the second user input the computing system is adapted to cause display of second video data generated by the third security camera within the first portion; and
the computing system is adapted to move the another visual representation of the fourth security camera from the second space to a third space within the first portion, the third space indicative of the location of the fourth security camera relative to a viewpoint of the third second security camera.

16. The security system of claim 15, wherein the computing system is adapted to cause display of a visual representation of the first security camera at a fourth space within the first portion, the fourth space indicative of the location of the first security camera relative to the viewpoint of the third security camera.

17. The security system of claim 10, wherein:
the second portion comprises a map of an area monitored by the security system; and
the visual representation of the third security camera is displayed at a position on the map that corresponds to the second location.

18. The security system of claim 10, wherein the second portion comprises a list of security cameras located nearby the first security camera.

19. A security system managing a plurality of security cameras adapted to generate video data, comprising:
a computing system adapted to receive video data associated with a first security camera at a first location;
the computing system adapted to cause display of the video data within a first portion of a graphical user interface;
the computing system adapted to cause display of a visual representation of a second security camera within a second portion of the graphical user interface, the second security camera at a second location;
the computing system adapted to detect a user interaction associated with the visual representation of the second security camera and a first space within the first portion of the graphical user interface, the first space indicative of a relationship between the second security camera and a viewpoint of the first security camera;
the computing system adapted to cause display of another visual representation of the second security camera at the first space;
the computing system adapted to determine an orientation value associated with the viewpoint of the first security camera based in part on the relationship; and
the computing system adapted to cause, based at least in part on the orientation value, display of a visual representation of the third security camera at a second space within the first portion of the graphical user interface.

20. The security system of claim 19, wherein:
the first security camera is a pan-tilt-zoom camera;
the computing system adapted to detect a change in a pan value of the first security camera;
the computing system adapted to determine an updated orientation value associated with the viewpoint of the first security camera based in part on the pan value; and
the computing system adapted to cause, based in part on the updated orientation value, movement of the another visual representation of the second security camera from the first space to a third space within the first portion of the first graphical user interface.
